(19) United States
(12) Patent Application Publication
(10) Pub. No.: US 2025/0279055 A1
(43) Pub. Date: Sep. 4, 2025

(54) DISPLAY DEVICE AND ELECTRONIC APPARATUS

(71) Applicant: SEIKO EPSON CORPORATION, Tokyo (JP)

(72) Inventors: Hitoshi OTA, SHIOJIRI-SHI (JP); Takehiko KUBOTA, MATSUMOTO-SHI (JP); Tsuyoshi TAMURA, HARA-MURA (JP)

(73) Assignee: SEIKO EPSON CORPORATION, Tokyo (JP)

(21) Appl. No.: 19/063,369

(22) Filed: Feb. 26, 2025

(30) Foreign Application Priority Data
Feb. 29, 2024 (JP) 2024-029628

(51) Int. Cl. G09G 3/3233

(52) U.S. Cl. CPC G09G 3/3233; G09G 2300/0819; G09G 2300/0842; G09G 2310/08

(57) ABSTRACT

A display device that includes a pixel circuit including first to fourth transistors and a light-emitting element, and a data potential generating circuit that generates a data potential, wherein in a first period, the second transistor is on, the third transistor and the fourth transistor are off, a gate of the first transistor is supplied with a first potential via a data line, in a second period, the second transistor and the third transistor are on, the fourth transistor is off, the data line and the gate and a drain of the first transistor are electrically coupled to each other, and in a third period, the second transistor is on, the third transistor and the fourth transistor are off, and the gate of the first transistor is supplied with the data potential via the data line and the second transistor.

The present application is based on, and claims priority from JP Application Serial Number 2024-029628, filed Feb. 29, 2024, the disclosure of which is hereby incorporated by reference herein in its entirety.

### BACKGROUND

### 1. Technical Field

The present disclosure relates to a display device and an electronic apparatus.

### 2. Related Art

There has been known a display device including a light-emitting element such as an organic electroluminescence (EL) element. In this display device, a large number of pixel circuits including a light-emitting element and a plurality of transistors used for driving the light-emitting element or controlling light emission timing are coupled to one data line.

For example, JP 2021-96418 A discloses a display device in which a threshold voltage of a driving transistor of a light-emitting element is held at one end of a coupling capacitance provided between a data line and a pixel circuit, and then data is written to the pixel circuit from another end of the coupling capacitance by a voltage change according to gradation data.

However, in the display device described in JP 2021-96418 A, when a load capacitance of the data line increases with an increase in the number of pixels and an increase in a screen size due to high definition of a display image, it is necessary to increase a capacitance value of the coupling capacitance in proportion to the increase in the load capacitance of the data line, and an area size of the display device increases.

### SUMMARY

An aspect of a display device according to the present disclosure includes
a scanning line,
a data line,
a pixel circuit provided corresponding to the scanning line and the data line, and
a data potential generating circuit configured to generate a data potential, wherein
the pixel circuit includes a first transistor, a second transistor, a third transistor, a fourth transistor, and a light-emitting element,
the first transistor supplies a current in accordance with a voltage between a gate and a source to the light-emitting element,
the second transistor controls electrical coupling between the data line and the gate of the first transistor in accordance with a potential of the scanning line,
the third transistor controls electrical coupling between the data line and a drain of the first transistor,
the fourth transistor controls electrical coupling between the light-emitting element and the drain of the first transistor,
in a first period,
the second transistor is on, the third transistor and the fourth transistor are off, and the gate of the first transistor is supplied with a predetermined first potential via the data line,
in a second period after the first period,
the second transistor and the third transistor are on, the fourth transistor is off, and the data line and the gate and the drain of the first transistor are electrically coupled to each other, and
in a third period after the second period,
the second transistor is on, the third transistor and the fourth transistor are off, and the gate of the first transistor is supplied with the data potential via the data line and the second transistor.

An aspect of an electronic apparatus according to the present disclosure includes an aspect of the display device described above.

### BRIEF DESCRIPTION OF THE DRAWINGS

FIG. 1 is a plan view schematically illustrating a display device of the embodiment.

FIG. 2 is a plan view schematically illustrating a display panel of the display device.

FIG. 3 is a block diagram illustrating an electrical configuration of the display device.

FIG. 4 is a diagram illustrating a configuration of a pixel circuit and a data line driving circuit in a first embodiment.

FIG. 5 is a timing chart illustrating an example of waveforms of various signals in the display device of the first embodiment.

FIG. 6 is a diagram for explaining operation of the display device of the first embodiment.

FIG. 7 is a diagram for explaining the operation of the display device of the first embodiment.

FIG. 8 is a diagram for explaining the operation of the display device of the first embodiment.

FIG. 9 is a diagram for explaining the operation of the display device of the first embodiment.

FIG. 10 is a diagram for explaining the operation of the display device of the first embodiment.

FIG. 11 is a diagram for explaining the operation of the display device of the first embodiment.

FIG. 12 is a diagram illustrating a configuration of a pixel circuit and a data line driving circuit in a second embodiment.

FIG. 13 is a timing chart illustrating an example of waveforms of various signals in a display device of the second embodiment.

FIG. 14 is a diagram for explaining operation of the display device of the second embodiment.

FIG. 15 is a diagram for explaining the operation of the display device of the second embodiment.

FIG. 16 is a diagram for explaining the operation of the display device of the second embodiment.

FIG. 17 is a diagram for explaining the operation of the display device of the second embodiment.

FIG. 18 is a diagram for explaining the operation of the display device of the second embodiment.

FIG. 19 is a diagram for explaining the operation of the display device of the second embodiment.

FIG. 20 is a perspective view schematically illustrating a head-mounted display according to the embodiment.

FIG. 21 is a diagram schematically illustrating an image forming device and a light-guiding device of the head-mounted display according to the embodiment.

### DESCRIPTION OF EMBODIMENTS

A preferred embodiment of the present disclosure is described in detail below using to the drawings. Note that the embodiments described below do not unduly limit the content of the present disclosure described in the claims. In addition, not all the configurations described below are essential constituent elements of the present disclosure.

### 1. Display Device

### 1-1. First Embodiment

### 1-1-1. Overall Configuration of Display Device

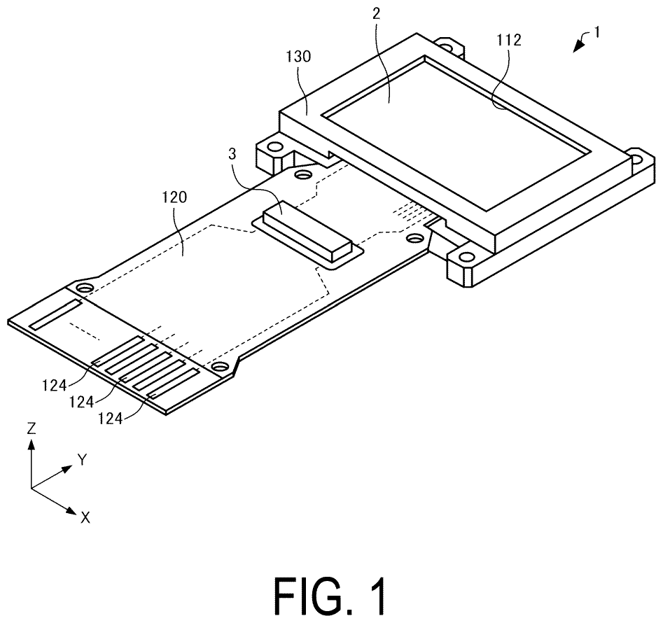

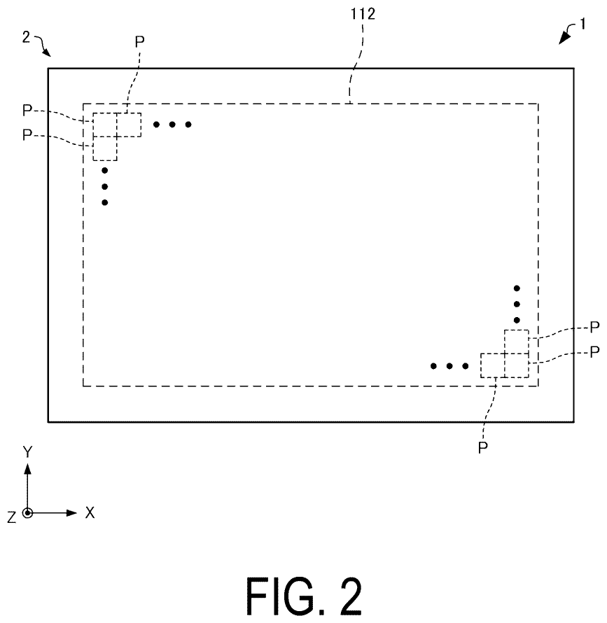

FIG. 1 is a perspective view schematically illustrating a display device 1 of the embodiment. FIG. 2 is a plan view schematically illustrating a display panel 2 of the display device 1 of the embodiment. Note that FIGS. 1 and 2 each illustrate an X-axis, a Y-axis, and a Z-axis as three axes orthogonal to each other.

The display device 1 is a micro display configured to display a color image, for example, in an HMD. HMD is an abbreviation for Head Mounted Display.

As illustrated in FIG. 1, the display device 1 includes the display panel 2, an FPC board 120, and a case 130. FPC is an abbreviation for Flexible Printed Circuit.

The display panel 2 includes a plurality of pixel circuits, and a driving circuit that drives the pixel circuit. In the embodiment, the plurality of pixel circuits and the driving circuit included in the display panel 2 are formed at a silicon substrate, and an OLED being light-emitting element is used in the pixel circuit. OLED is an abbreviation for Organic Light emitting Diode.

As illustrated in FIG. 2, the display panel 2 includes a display region 112. In the example illustrated in the drawing, the display region 112 is a rectangle with long sides parallel to the X-axis. In the display region 112, a plurality of pixels P as display units are displayed in a matrix at a predetermined arrangement pitch. In the example illustrated in the drawing, the plurality of pixels P are displayed in a matrix in the X-axis direction and the Y-axis direction. The pixel P may have luminance information and may further have color information. When the pixel P has luminance information and does not have color information, a black and white image is displayed in the display region 112. On the other hand, when the pixel P has luminance information and color information, a color image is displayed in the display region 112. Hereinafter, description will be given assuming that the pixel P has luminance information and color information.

As illustrated in FIG. 1, the display panel 2 is housed and fixed at the frame-shaped case 130 that opens in the display region 112, and one end of the FPC board 120 is coupled thereto. Another end of the FPC board 120 is provided with a plurality of external coupling terminals 124, and the plurality of external coupling terminals 124 are coupled to an external circuit (not illustrated). A control circuit 3 being a semiconductor chip is mounted at the FPC board 120 by a COF technique, and synchronization signals and image data synchronized with the synchronization signals are supplied from the external circuit via the plurality of external coupling terminals 124. COF is an abbreviation for Chip On Film. The synchronization signals include a vertical synchronization signal for giving an instruction for starting vertical scanning of image data, a horizontal synchronization signal for giving an instruction for starting horizontal scanning of the image data, and a dot clock signal that indicates timing corresponding to one pixel of the image data.

The control circuit 3 supplies various control signals and various potentials generated according to the synchronization signal to the display panel 2, and supplies data corresponding to each pixel P included in the image data to the display panel 2 in a time-division manner.

### 1-1-2. Functional Configuration of Display Device

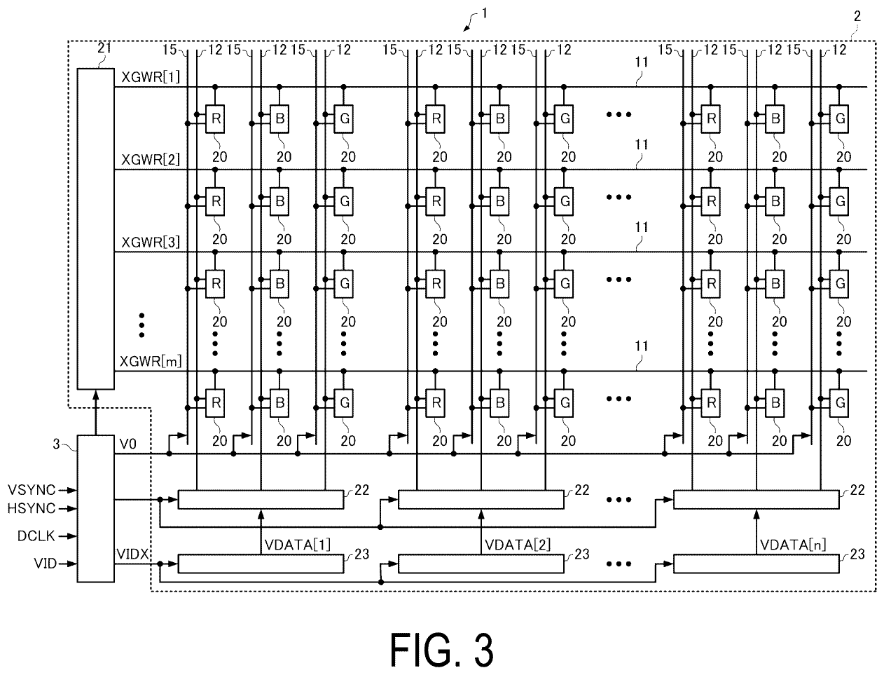

FIG. 3 is a block diagram illustrating an electrical configuration of the display device 1. As illustrated in FIG. 3, the display device 1 includes the control circuit 3, a plurality of pixel circuits 20, a scanning line driving circuit 21, a plurality of data line driving circuits 22, and a plurality of data potential generating circuits 23. The plurality of pixel circuits 20, the scanning line driving circuit 21, the plurality of data line driving circuits 22, and the plurality of data potential generating circuits 23 are provided at the display panel 2. As described above, the control circuit 3 is mounted at the FPC board 120, but may be provided at the display panel 2.

The display panel 2 is provided with m scanning lines 11 along a lateral direction in the drawing, and 3n data lines 12 along a vertical direction in the drawing. In FIG. 3, the lateral direction corresponds to a direction of the X-axis in FIGS. 1 and 2, and the vertical direction corresponds to a direction of the Y-axis in FIGS. 1 and 2. Note that each of m and n is an integer greater than or equal to two. Then, m×3n pixel circuits 20 are provided corresponding to the m scanning lines 11 and the 3n data lines 12. That is, one pixel circuit 20 is provided corresponding to one scanning line 11 and one data line 12, and the m×3n pixel circuits 20 are arrayed in a matrix of m rows in the vertical direction and 3n columns in the lateral direction.

The 3n data lines 12 form groups each including three lines, and are divided into n groups. Among the n groups, a j-th group from a left includes the data line 12 in a (3j-2)-th column, the data line 12 in a (3j-1)-th column, and the data-line 12 in a 3j-th column. Note that j is an integer from 1 to n. n pixel circuits 20 that emit red light are coupled to the data line 12 in the (3j-2)-th column, n pixel circuits 20 that emit blue light are coupled to the data line 12 in the (3j-1)-th column, and n pixel circuits 20 that emit green light are coupled to the data line 12 in the 3j-th column. In FIG. 3, the pixel circuit 20 that emits red light is denoted by “R”, the pixel circuit 20 that emits blue light is denoted by “B”, and the pixel circuit 20 that emits green light is denoted by “G”.

Then, three pixel circuits 20 coupled to the scanning line 11 in an i-th row and respectively coupled to three data lines 12 included in a j-th group respectively correspond to a red pixel, a blue pixel, and a green pixel constituting the pixel P in the i-th row and a j-th column. That is, a color of the pixel P is expressed by additive color mixing by the three pixel circuits 20 corresponding to the respective pixels of red, blue, and green. Note that i is an integer from 1 to m.

Further, the display panel 2 is provided with 3n power supply lines 15 along the vertical direction. m pixel circuits 20 corresponding to red pixels are coupled to the power suppl line 15 in the (3j-2)-th column, m pixel circuits 20 corresponding to blue pixels are coupled to the power supply line 15 in the (3j-1)-th column, and m pixel circuits 20 corresponding to green pixels are coupled to the power supply line 15 in the 3j-th column. The 3n power supply lines 15 are commonly supplied with a potential V0 from the control circuit 3. Note that the potential V0 is, for example, a ground potential VSS that is a reference of a zero potential, or a potential close to the ground potential VSS. To be specific, the potential V0 is a potential so small that when applied to a light-emitting element included in each pixel circuit 20, a current does not flow through the light-emitting element.

The control circuit 3 controls each unit, based on image data VID, a vertical synchronization signal VSYNC, a horizontal synchronization signal HSYNC, and a dot clock signal DCLK that are supplied from the external circuit. The image data VID is data that defines a gray scale level of each pixel P of an image to be displayed in the display region 112 for each of RGB, using 8 bits, for example. That is, the image data VID is data in which 24-bit RGB data corresponding to luminance information and color information of each pixel P is switched for each cycle of the dot clock signal DCLK.

Here, brightness characteristics indicated by a gray scale level does not coincide with luminance characteristics of the light-emitting element included in the pixel circuit 20, and thus the control circuit 3 converts the image data VID that designates the gray scale level of the pixel P into image data VIDX that designates a luminance corresponding to the gray scale level. That is, the control circuit 3 generates the image data VIDX by performing up-conversion of 8 bits of R data, 8 bits of G data, and 8 bits of B data of each pixel P included in the image data VID into, for example, 10 bits of R data, 10 bits of G data, and 10 bits of B data, respectively, for designating a luminance of a corresponding light-emitting element. For such up-conversion, a look-up table is used in which correspondence relationships between 8 bits of R data, 8 bits of G data, and 8 bits of B data and 10 bits of R data, 10 bits of G data, and 10 bits of B data are stored in advance.

The scanning line driving circuit 21 is a circuit for driving the pixel circuits 20 arrayed in the m rows and 3n columns row by row in accordance with the control by the control circuit 3, and outputs various types of signals. For example, the scanning line driving circuit 21 supplies scanning signals XGWR[1] to XGWR[m] to the scanning lines 11 in first to m-th rows in order, respectively. That is, the scanning line 11 in the i-th row is supplied with a scanning signal XGWR[i].

One data line driving circuit 22 and one data potential generating circuit 23 are provided for three data lines 12 included in the same group. As described above, the 3n lines 12 are divided into the n groups, thus the display panel 2 includes n data line driving circuits 22 and n data potential generating circuits 23.

A j-th data potential generating circuit 23 from the left generates data potentials VDATA[j] to be supplied to the respective data lines 12 in the (3j−2)-th column, the (3j−1)-th column, and the 3j-th column according to the control by the control circuit 3 and based on the image data VIDX supplied from the control circuit 3. Specifically, the j-th data potential generating circuit 23 includes a D/A converter circuit and an amplifier circuit, and the D/A converter circuit acquires R data, B data, and G data of each of m pixels P in the j-th column included in the image data VIDX output from the control circuit 3 at timing designated by the control circuit 3 and performs D/A conversion in a time-division manner. Further, the amplifier circuit amplifies a potential after the D/A conversion and outputs the data potential VDATA[j]. That is, the data potential VDATA[j] is switched in a time-division manner at a time when the R data, the B data, or the G data are written to 3m pixel circuits 20 corresponding to the m pixels P in the j-th column.

A j-th data line driving circuit 22 from the left is coupled to three data lines 12 in the (3j−2)-th column, the (3j−1)-th column, and the 3j-th column. The j-th data line driving circuit 22 outputs R data, B data, and G data included in the data potential VDATA[j] in a time-division manner output from the j-th data potential generating circuit 23 to the respective data lines 12 in the (3j−2)-th column, the (3j−1)-th column, and the 3j-th column in accordance with the control by the control circuit 3 at a time when the RGB data is written to three pixel circuits corresponding to the pixel P in the i-th row and the j-th column.

Note that various control signals and various potentials are supplied to the display panel 2 by the control circuit 3, but are only partially illustrated in FIG. 3.

### 1-1-3. Configuration of Pixel Circuit and Data Line Driving Circuit

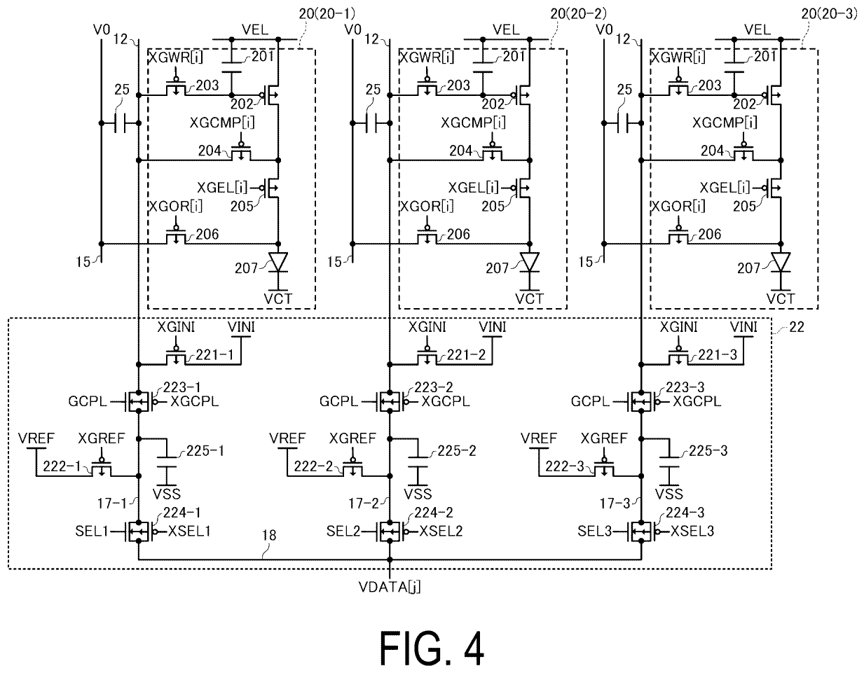

FIG. 4 is a diagram illustrating a configuration of three pixel circuits 20 corresponding to the pixel P in the i-th row and the j-th column and the j-th data line driving circuit 22. For convenience of description, in FIG. 4, the three pixel circuits 20 corresponding to the pixel P in the i-th row and the j-th column are distinguished as pixel circuits 20-1, 20-2, and 20-3, respectively, but configurations of the three pixel circuits 20 are the same, and the same components are denoted by the same reference numerals. The pixel circuit 20-1 is the pixel circuit 20 corresponding to a red pixel of the pixel P, the pixel circuit 20-2 is the pixel circuit 20 corresponding to a blue pixel of the pixel P, and the pixel circuit 20-3 is the pixel circuit 20 corresponding to a green pixel of the pixel P.

As illustrated in FIG. 4, the pixel circuit 20 includes a capacitance element 201, P-channel type MOSFETs 202 to 206, and a light-emitting element 207. MOS is an abbreviation for Metal Oxide Semiconductor Field Effect Transistor.

The light-emitting element 207 is an OLED, and has a structure in which a light-emitting functional layer is sandwiched between a pixel electrode and a common electrode (not illustrated). The pixel electrode functions as an anode, the common electrode has optical transparency, and functions as a cathode. In the light-emitting element 207, when a current flows from the anode toward the cathode, holes injected from the anode and electrons injected from the cathode are recombined in the light-emitting functional layer to generate excitons, and white light is generated. Then, the generated white light resonates in an optical resonator configured of a reflective layer and a semi-reflective and semi-transmissive layer (not illustrated), and is emitted at a resonance wavelength set corresponding to any of red, green, and blue. A color filter corresponding to the color is provided on an emission side of light from the optical resonator. Thus, the emitted light from the light-emitting element 207 is visually recognized by an observer through coloration by the optical resonator and the color filter. Note that when a black-and-white image is displayed in the display region 112, the color filter is omitted.

One end of the capacitance element 201 is supplied with a potential VEL from the control circuit 3, and another end of the capacitance element 201 is coupled to a gate of the MOSFET 202 and a drain of the MOSFET 203. A source of the MOSFET 202 is supplied with the potential VEL, and a drain of the MOSFET 202 is coupled to a drain of the MOSFET 204 and a source of the MOSFET 205. A drain of the MOSFET 205 is coupled to a drain of the MOSFET 206 and an anode of the light-emitting element 207. A cathode of the light-emitting element 207 is supplied with a potential VCT from the control circuit 3.

A source of the MOSFET 203 and a source of the MOSFET 204 are coupled to the data line 12. A source of the MOSFET 206 is coupled to the power supply line 15 and is supplied with the potential V0 from the control circuit 3.

The scanning signal XGWR[i] is input from the scanning line driving circuit 21 to a gate of the MOSFET 203. A control signal XGCMP[i] is input from the scanning line driving circuit 21 to a gate of the MOSFET 204. A control signal XGEL[i] is input from the scanning line driving circuit 21 to a gate of the MOSFET 205. A control signal XGOR[i] is input from the scanning line driving circuit 21 to a gate of the MOSFET 206.

The MOSFET 202 supplies a current corresponding to a voltage between the gate and the source to the light-emitting element 207. To be more specific, as the voltage between the gate and the source of the MOSFET 202 becomes higher, a current flowing through the light-emitting element 207 becomes larger and an amount of light emitted from the light-emitting element 207 becomes larger.

The MOSFET 203 controls the electrical coupling between the data line 12 and the gate of the MOSFET 202 according to a potential of the scanning line 11. To be more specific, when the scanning signal XGWR[i] supplied to the scanning line 11 is at an L level, the MOSFET 203 is on and the data line 12 and the gate of the MOSFET 202 are electrically coupled to each other, and when the scanning signal XGWR[i] is at an H level, the MOSFET 203 is off and the data line 12 and the gate of the MOSFET 202 are electrically disconnected from each other.

The MOSFET 204 controls the electrical coupling between the data line 12 and the drain of the MOSFET 202. To be specific, when the control signal XGCMP[i] is at the L level, the MOSFET 204 is on and the data line 12 and the drain of the MOSFET 202 are electrically coupled to each other, and when the control signal XGCMP[i] is at the H level, the MOSFET 204 is off and the data line 12 and the drain of the MOSFET 202 are electrically disconnected from each other.

The MOSFET 205 controls electrical coupling between the light-emitting element 207 and the drain of the MOSFET 202. To be specific, when the control signal XGEL[i] is at the L level, the MOSFET 205 is on and the anode of the light-emitting element 207 and the drain of the MOSFET 202 are electrically coupled to each other, and when the control signal XGEL[i] is at the H level, the MOSFET 205 is off and the anode of the light-emitting element 207 and the drain of the MOSFET 202 are electrically disconnected from each other.

The MOSFET 206 controls electrical coupling between the power supply line 15 and the light-emitting element 207. To be specific, when the control signal XGOR[i] is at the L level, the MOSFET 206 is on and the power supply line 15 and the anode of the light-emitting element 207 are electrically coupled to each other, and when the control signal XGOR[i] is at the H level, the MOSFET 206 is off and the power supply line 15 and the anode of the light-emitting element 207 are electrically disconnected from each other.

As illustrated in FIG. 4, a capacitor 25 is provided between the data line 12 coupled to the pixel circuit 20 and the power supply line 15. The capacitor 25 may be a parasitic capacitor between the data line 12 and the power supply line 15, or may be a capacitor formed by sandwiching an insulating layer between mutually different conductive layers at a silicon substrate.

As illustrated in FIG. 4, the data line driving circuit 22 includes P-channel type MOSFETs 221-1, 221-2, 221-3, 222-1, 222-2, 222-3, switch circuits 223-1, 223-2, 223-3, 224-1, 224-2, 224-3, capacitance elements 225-1, 225-2, and 225-3.

Each of the switch circuits 223-1, 223-2, 223-3, 224-1, 224-2, and 224-3 is a transmission gate in which sources and drains of an N-channel type MOSFET and a P-channel type MOSFET are coupled, respectively. Hereinafter, in each of the switch circuits 223-1, 223-2, 223-3, 224-1, 224-2, and 224-3, a gate of the N-channel MOSFET is referred to as a “first control terminal”, a gate of the P-channel MOSFET is referred to as a “second control terminal”, a coupling node between a source of the N-channel MOSFET and a source of the P-channel MOSFET is referred to as an “input terminal”, and a coupling node between a drain of the N-channel MOSFET and a drain of the P-channel MOSFET is referred to as an “output terminal”.

A source of the MOSFET 221-1 is supplied with a potential VINI from the control circuit 3, and a drain of the MOSFET 221-1 is coupled to the data line 12 coupled to the pixel circuit 20-1. A source of the MOSFET 222-1 is supplied with a potential VREF from the control circuit 3, and a drain of the MOSFET 222-1 is coupled to a data transfer line 17-1. An input terminal of the switch circuit 223-1 is coupled to the data transfer line 17-1, and an output terminal of the switch circuit 223-1 is coupled to the data line 12 coupled to the pixel circuit 20-1. An input terminal of the switch circuit 224-1 is coupled to a data supply line 18, and an output terminal of the switch circuit 224-1 is coupled to the data transfer line 17-1. One end of the capacitance element 225-1 is coupled to the data transfer line 17-1, and another end of the capacitance element 225-1 is supplied with the ground potential VSS.

Similarly, a source of the MOSFET 221-2 is supplied with the potential VINI from the control circuit 3, and a drain of the MOSFET 221-2 is coupled to the data line 12 coupled to the pixel circuit 20-2. A source of the MOSFET 222-2 is supplied with the potential VREF from the control circuit 3, and a drain of the MOSFET 222-2 is coupled to a data transfer line 17-2. An input terminal of the switch circuit 223-2 is coupled to the data transfer line 17-2, and an output terminal of the switch circuit 223-2 is coupled to the data line 12 coupled to the pixel circuit 20-2. An input terminal of the switch circuit 224-2 is coupled to the data supply line 18, and an output terminal of the switch circuit 224-2 is coupled to the data transfer line 17-2. One end of the capacitance element 225-2 is coupled to the data transfer line 17-2, and another end of the capacitance element 225-2 is supplied with the ground potential VSS.

Similarly, a source of the MOSFET 221-3 is supplied with the potential VINI from the control circuit 3, and a drain of the MOSFET 221-3 is coupled to the data line 12 coupled to the pixel circuit 20-3. A source of the MOSFET 222-3 is supplied with the potential VREF from the control circuit 3, and a drain of the MOSFET 222-3 is coupled to a data transfer line 17-3. An input terminal of the switch circuit 223-3 is coupled to the data transfer line 17-3, and an output terminal of the switch circuit 223-3 is coupled to the data line 12 coupled to the pixel circuit 20-3. An input terminal of the switch circuit 224-3 is coupled to the data supply line 18, and an output terminal of the switch circuit 224-3 is coupled to the data transfer line 17-3. One end of the capacitance element 225-3 is coupled to the data transfer line 17-3, and another end of the capacitance element 225-3 is supplied with the ground potential VSS.

The data supply line 18 is supplied with the data potential VDATA[j] generated by the j-th data potential generating circuit 23.

A control signal XGINI is input from the control circuit 3 to a gate of each of the MOSFETs 221-1, 221-2, and 221-3. A control signal XGREF is input from the control circuit 3 to a gate of each of the MOSFETs 222-1, 222-2, and 222-3.

A control signal GCPL is input from the control circuit 3 to a first control terminal of each of the switch circuits 223-1, 223-2, and 223-3, and a control signal XGCPL is input from the control circuit 3 to a second control terminal of each of the switch circuits 223-1, 223-2, and 223-3. The control signal GCPL and the control signal XGCPL are digital signals for which logic levels are inverted from each other.

A control signal SEL1 is input from the control circuit 3 to a first control terminal of the switch circuit 224-1, and a control signal XSEL1 is input from the control circuit 3 to a second control terminal of the switch circuit 224-1. The control signal SEL1 and the control signal XSEL1 are digital signals for which logic levels are inverted from each other.

A control signal SEL2 is input from the control circuit 3 to a first control terminal of the switch circuit 224-2, and a control signal XSEL2 is input from the control circuit 3 to a second control terminal of the switch circuit 224-2. The control signal SEL2 and the control signal XSEL2 are digital signals for which logic levels are inverted from each other.

A control signal SEL3 is input from the control circuit 3 to a first control terminal of the switch circuit 224-3, and a control signal XSEL3 is input from the control circuit 3 to a second control terminal of the switch circuit 224-3. The control signal SEL3 and the control signal XSEL3 are digital signals for which logic levels are inverted from each other.

The MOSFET 221-1 controls supply of the potential VINI to the data line 12 coupled to the pixel circuit 20-1. The MOSFET 221-2 controls supply of the potential VINI to the data line 12 coupled to the pixel circuit 20-2. The MOSFET 221-3 controls supply of the potential VINI to the data line 12 coupled to the pixel circuit 20-3. To be more specific, when the control signal XGINI is at the L level, the MOSFET 221-1 is on and the data line 12 coupled to the pixel circuit 20-1 is supplied with the potential VINI, the MOSFET 221-2 is on and the data line 12 coupled to the pixel circuit 20-2 is supplied with the potential VINI, and the MOSFET 221-3 is on and the data-line 12 coupled to the pixel circuit 20-3 is supplied with the potential VINI. Further, when the control signal XGINI is at the H level, the MOSFET 221-1 is off and the data line 12 coupled to the pixel circuit 20-1 is not supplied with the potential VINI, the MOSFET 221-2 is off and the data line 12 coupled to the pixel circuit 20-2 is not supplied with the potential VINI, and the MOSFET 221-3 is off and the data-line 12 coupled to the pixel circuit 20-3 is not supplied with the potential VINI.

The MOSFET 222-1 controls supply of the potential VREF to the data transfer line 17-1. The MOSFET 222-2 controls supply of the potential VREF to the data transfer line 17-2. The MOSFET 222-3 controls supply of the potential VREF to the data transfer line 17-3. To be specific, when the control signal XGREF is at the L level, the MOSFET 222-1 is on and the data transfer line 17-1 is supplied with the potential VREF, the MOSFET 222-2 is on and the data transfer line 17-2 is supplied with the potential VREF, and the MOSFET 222-3 is on and the data transfer line 17-3 is supplied with the potential VREF. Further, when the control signal XGREF is at the H level, the MOSFET 222-1 is off and the data transfer line 17-1 is not supplied with the potential VREF, the MOSFET 222-2 is off and the data transfer line 17-2 is not supplied with the potential VREF, and the MOSFET 222-3 is off and the data transfer line 17-3 is not supplied with the potential VREF.

The switch circuit 223-1 controls electrical coupling between the data line 12 coupled to the pixel circuit 20-1 and the data transfer line 17-1. The switch circuit 223-2 controls electrical coupling between the data line 12 coupled to the pixel circuit 20-2 and the data transfer line 17-2. The switch circuit 223-3 controls electrical coupling between the data line 12 coupled to the pixel circuit 20-3 and the data transfer line 17-3. Specifically, when the control signals GCPL and XGCPL are at the H level and the L level, respectively, the switch circuit 223-1 is on and the data line 12 coupled to the pixel circuit 20-1 and the data transfer line 17-1 are electrically coupled to each other, the switch circuit 223-2 is on and the data line 12 coupled to the pixel circuit 20-2 and the data transfer line 17-2 are electrically coupled to each other, and the switch circuit 223-3 is on and the data line 12 coupled to the pixel circuit 20-3 and the data transfer line 17-3 are electrically coupled to each other. Further, when the control signals GCPL and XGCPL are at the L level and the H level, respectively, the switch circuit 223-1 is off and the data line 12 coupled to the pixel circuit 20-1 and the data transfer line 17-1 are electrically disconnected from each other, the switch circuit 223-2 is off and the data line 12 coupled to the pixel circuit 20-2 and the data transfer line 17-2 are electrically disconnected from each other, and the switch circuit 223-3 is off and the data line 12 coupled to the pixel circuit 20-3 and the data transfer line 17-3 are electrically disconnected from each other.

The switch circuit 224-1 controls electrical coupling between the data transfer line 17-1 and the data supply line 18. The switch circuit 224-2 controls electrical coupling between the data transfer line 17-2 and the data supply line 18. The switch circuit 224-3 controls electrical coupling between the data transfer line 17-3 and the data supply line 18. To be more specific, when the control signals SEL1 and XSEL1 are at the H level and the L level, respectively, the switch circuit 224-1 is on and the data transfer line 17-1 and the data supply line 18 are electrical coupled to each other, and when the control signals SEL1 and XSEL1 are at the L level and the H level, respectively, the switch circuit 224-1 is off and the data transfer line 17-1 and the data supply line 18 are electrically disconnected from each other. Further, when the control signals SEL2 and XSEL2 are at the H level and the L level, respectively, the switch circuit 224-2 is on and the data transfer line 17-2 and the data supply line 18 are electrical coupled to each other, and when the control signals SEL2 and XSEL2 are at the L level and the H level, respectively, the switch circuit 224-2 is off and the data transfer line 17-2 and the data supply line 18 are electrically disconnected from each other. Further, when the control signals SEL3 and XSEL3 are at the H level and the L level, respectively, the switch circuit 224-3 is on and the data transfer line 17-3 and the data supply line 18 are electrical coupled to each other, and when the control signals SEL3 and XSEL3 are at the L level and the H level, respectively, the switch circuit 224-3 is off and the data transfer line 17-3 and the data supply line 18 are electrically disconnected from each other.

Then, when the data transfer line 17-1 and the data supply line 18 are electrically coupled to each other by the switch circuit 224-1, the data potential VDATA[j] is transferred from the data supply line 18 to the data transfer line 17-1. Similarly, when the data transfer line 17-2 and the data supply line 18 are electrically coupled to each other by the switch circuit 224-2, the data potential VDATA[j] is transferred from the data supply line 18 to the data transfer line 17-1. Similarly, when the data transfer line 17-3 and the data supply line 18 are electrically coupled to each other by the switch circuit 224-3, the data potential VDATA[j] is transferred from the data supply line 18 to the data transfer line 17-1.

Note that the control signals XGINI, XGREF, GCPL, XGCPL, SEL1, XSEL1, SEL2, XSEL2, SEL3, and XSEL3 are input in common to the n data line driving circuits 22.

### 1-1-4. Operation of Display Device

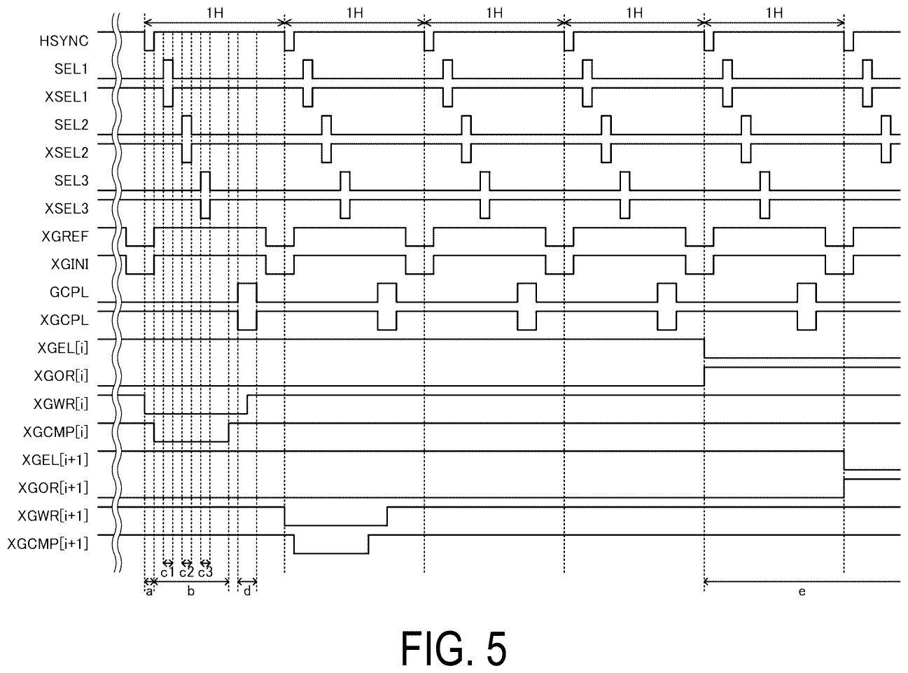

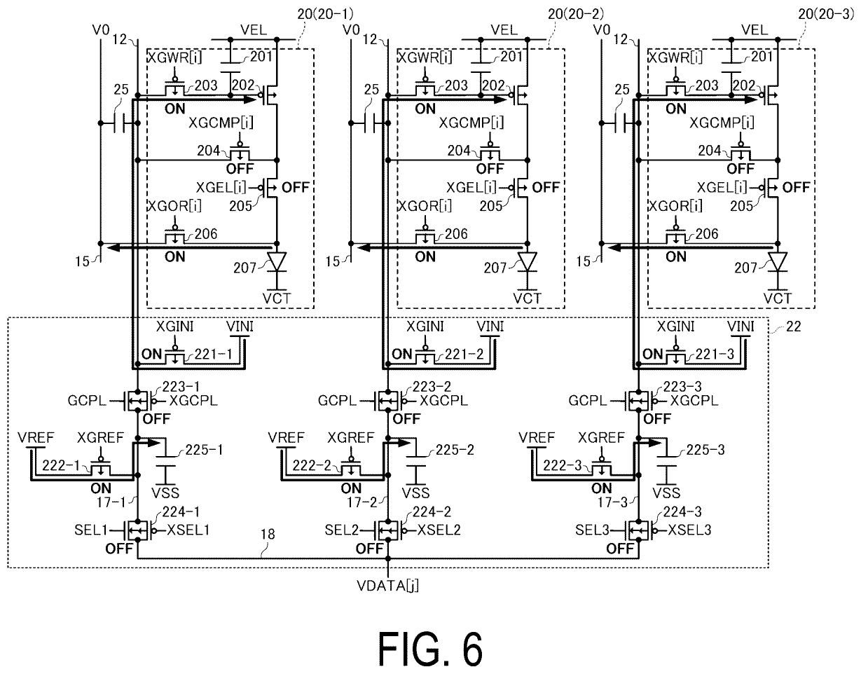

Operation of the display device 1 will be described with reference to FIGS. 5 to 11. FIG. 5 is a timing chart illustrating an example of waveforms of various signals in the display device 1. Further, FIGS. 6 to 11 are diagrams obtained by adding ON/OFF of the MOSFETs and the switch circuits in each period and supply paths of various potentials to FIG. 4.

As illustrated in FIG. 5, a period of one cycle from a time when the horizontal synchronization signal HSYNC input from the external circuit of the display device 1 transitions from the H level to the L level to a time when the horizontal synchronization signal HSYNC next transitions from the H level to the L level corresponds to a horizontal scanning period 1H. In each horizontal scanning period 1H, data is written to 3n pixel circuits 20 corresponding to n pixels P in each row. In each horizontal scanning period 1H, the scanning line driving circuit 21 commonly outputs the control signals XGEL[i], XGOR[i], and XGCMP[i] and the scanning signal XGWR[i] to 3n pixel circuits 20 corresponding to n pixels P in the i-th row. Further, the control circuit 3 commonly outputs the control signals XGINI, XGREF, GCPL, XGCPL, SEL1, XSEL1, SEL2, XSEL2, SEL3, and XSEL3 to the n data line driving circuits 22. Note that FIG. 5 is a timing chart focusing on the horizontal scanning period 1H for the i-th row after the horizontal scanning periods 1H for first to (i−1)-th rows ended.

As illustrated in FIG. 5, the horizontal scanning period 1H for the i-th row includes an initialization period a, a compensation period b after the initialization period a, and a writing period d after the compensation period b. Further, the horizontal scanning period 1H for the i-th row includes a first transfer period c1, a second transfer period c2 after the first transfer period c1, and a third transfer period c3 after the second transfer period c2, each overlapping a part of the compensation period b. Then, after the writing period d, after a while, a light-emitting period e is reached, and after a period of one frame elapses, the horizontal scanning period 1H for the i-th row is reached again. Note that the period of one frame corresponds to a period of one cycle of the vertical synchronization signal VSYNC, and is a period required to display one shot of an image designated by the image data VID. For example, when a frequency of the vertical synchronization signal VSYNC is 60 Hz, the period of one frame is about 16.7 milliseconds.

As illustrated in FIG. 5, in the horizontal scanning period 1H for the i-th row, the scanning signal XGWR[i] is at the L level in the initialization period a. Further, the control signal XGOR[i] is at the L level, and the control signals XGEL[i] and XGCMP[i] are at the H level. Further, the control signals XGREF and XGINI are at the L level. Further, the control signals SEL1, SEL2, SEL3, and GCPL are at the L level, and the control signals XSEL1, XSEL2, XSEL3, and XGCPL are at the H level. Therefore, as illustrated in FIG. 6, in the initialization period a, the MOSFETs 203 and 206 are on and the MOSFETs 204 and 205 are off in each of the pixel circuits 20-1, 20-2, and 20-3. Further, in the data line driving circuit 22, the MOSFETs 221-1, 221-2, 221-3, 222-1, 222-2, and 222-3 are on, and the switch circuits 223-1, 223-2, 223-3, 224-1, 224-2, and 224-3 are off. Therefore, in each of the pixel circuits 20-1, 20-2, and 20-3, the gate of the MOSFET 202 and the other end of the capacitance element 201 are supplied with the predetermined potential VINI via the data line 12. Further, the anode of the light-emitting element 207 is supplied with the potential V0 via the power supply line 15. That is, the potentials of the data line 12, the gate of the MOSFET 202, and the other end of the capacitance element 201 are initialized to the potential VINI, and the potential of the anode of the light-emitting element 207 is initialized to the potential V0. In addition, in the data line driving circuit 22, the data transfer lines 17-1, 17-2, and 17-3 are supplied with the potential VREF, and voltages at both ends of each of the capacitance elements 225-1, 225-2, and 225-3 are initialized to a voltage of a difference between the potential VREF and the ground potential VSS.

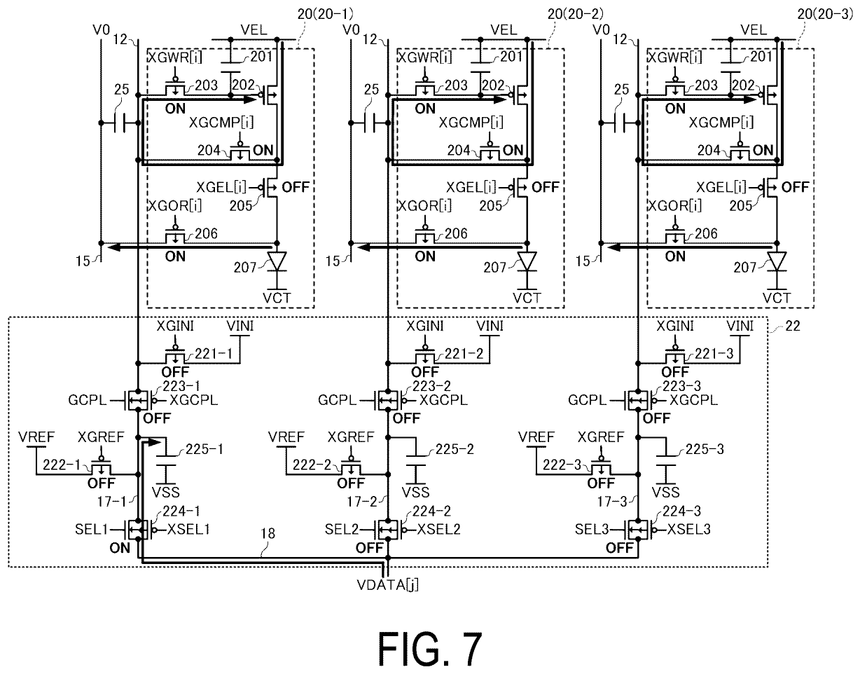

As illustrated in FIG. 5, in the horizontal scanning period 1H for the i-th row, the scanning signal XGWR[i] is at the L level in the compensation period b. Further, the control signals XGOR[i] and XGCMP[i] are at the L level, and the control signal XGEL[i] is at the H level. Further, the control signals XGREF and XGINI are at the H level. Further, the control signal GCPL is at the H level, and the control signal XGCPL is at the L level. Therefore, as illustrated in FIGS. 7, 8, and 9, in the compensation period b, the MOSFETs 203, 204, and 206 are on and the MOSFET 205 is off in each of the pixel circuits 20-1, 20-2, and 20-3. Further, in the data line driving circuit 22, the MOSFETS 221-1, 221-2, 221-3, 222-1, 222-2, and 222-3 are off, and the switch circuits 223-1, 223-2, and 223-3 are off. Therefore, in each of the pixel circuits 20-1, 20-2, and 20-3, a current flows from the power supply line at the potential VEL to the gate of the MOSFET 202 via the MOSFETs 202, 204, and 205, and the potentials of the data line 12, the gate of the MOSFET 202 and the other end of the capacitance element 201 rise from the potential VINI. At this time, since the MOSFET 202 is in a state in which the gate and the drain are coupled to each other, that is, in a diode-coupled state, the voltage between the gate and the source in the MOSFET 202 converges to a threshold voltage Vth of the MOSFET 202. Since the MOSFET 202 is of the P-channel type, the threshold voltage Vth is a negative voltage. Since the source of the MOSFET 202 is supplied with the potential VEL, the potentials of the data line 12, the gate of the MOSFET 202, and the other end of the capacitance element 201 converge to a potential (VEL−|Vth|). Further, the potential of the anode of the light-emitting element 207 is maintained at the potential V0.

Additionally, as illustrated in FIG. 7, in the first transfer period c1 overlapping a part of the compensation period b, the switch circuit 224-1 is on and the switch circuits 223-1, 223-2, 223-3, 224-2, and 224-3 are off in the data line driving circuit 22. Therefore, in the data line driving circuit 22, a current flows from the data supply line 18 to the capacitance element 225-1 via the switch circuit 224-1 and the data transfer line 17-1, and voltages at both ends of the capacitance element 225-1 become a voltage of a difference between the data potential VDATA[j] and the ground potential VSS. That is, the data potential VDATA[j] for the pixel circuit 20-1 is held in the capacitance element 225-1.

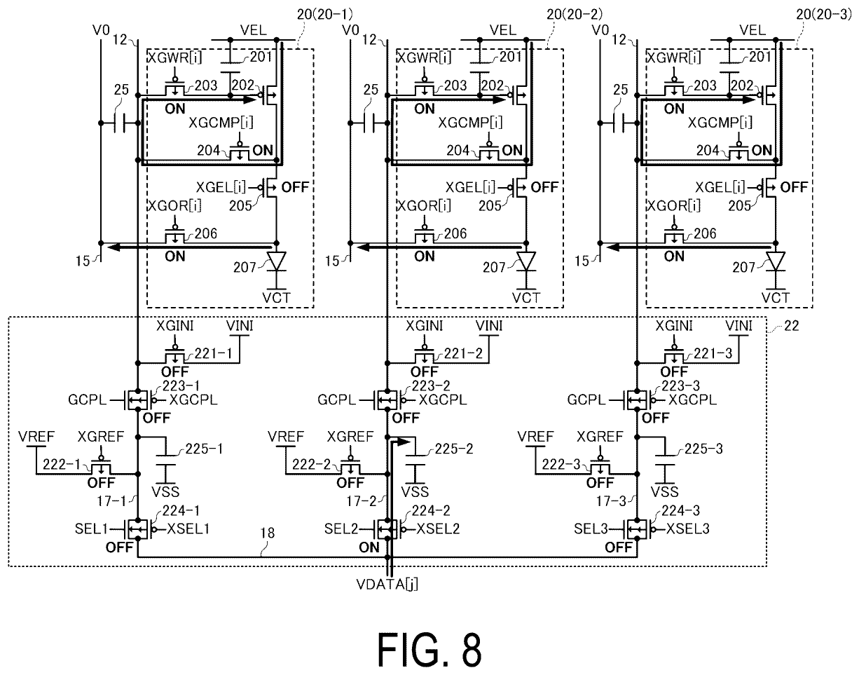

Additionally, as illustrated in FIG. 8, in the second transfer period c2 overlapping a part of the compensation period b, the switch circuit 224-2 is on and the switch circuits 223-1, 223-2, 223-3, 224-1, and 224-3 are off in the data line driving circuit 22. Therefore, in the data line driving circuit 22, a current flows from the data supply line 18 to the capacitance element 225-2 via the switch circuit 224-2 and the data transfer line 17-2, and voltages at both ends of the capacitance element 225-2 become the voltage of the difference between the data potential VDATA[j] and the ground potential VSS. That is, the data potential VDATA[j] for the pixel circuit 20-2 is held in the capacitance element 225-2.

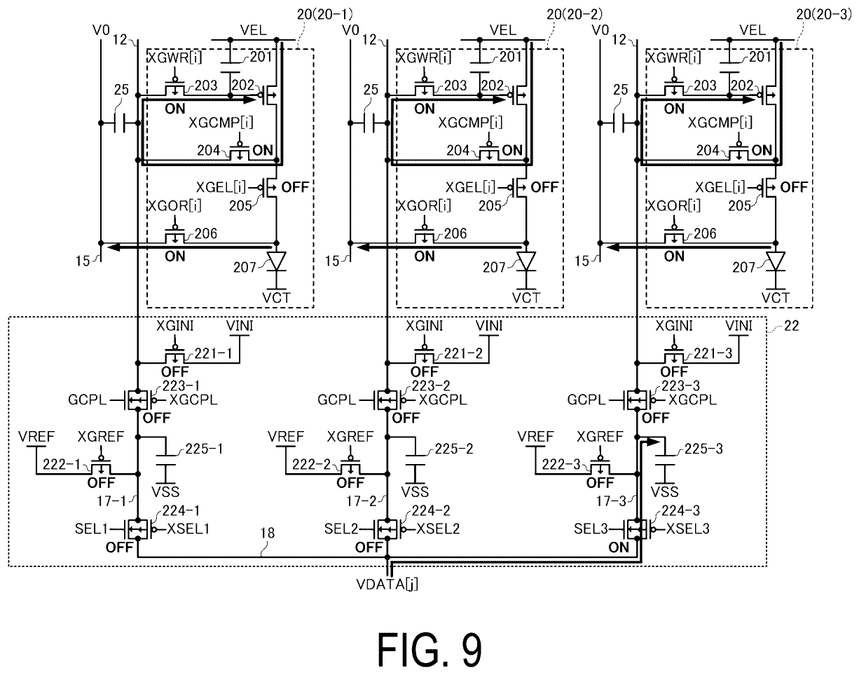

Additionally, as illustrated in FIG. 9, in the third transfer period c3 overlapping a part of the compensation period b, the switch circuit 224-3 is on and the switch circuits 223-1, 223-2, 223-3, 224-1, and 224-2 are off in the data line driving circuit 22. Therefore, in the data line driving circuit 22, a current flows from the data supply line 18 to the capacitance element 225-3 via the switch circuit 224-3 and the data transfer line 17-3, and voltages at both ends of the capacitance element 225-3 become the voltage of the difference between the data potential VDATA[j] and the ground potential VSS. That is, the data potential VDATA[j] for the pixel circuit 20-3 is held in the capacitance element 225-3.

As described above, the first transfer period c1, the second transfer period c2, and the third transfer period c3 each overlap a part of the compensation period b, in other words, in the compensation period b, the data potentials VDATA[j] output from the data potential generating circuit 23 are sequentially transferred from the data supply line 18 to the data transfer lines 17-1, 17-2, and 17-3, and the data potentials VDATA[j] respectively transferred to the data transfer lines 17-1, 17-2, and 17-3 are held in the capacitance elements 225-1, 225-2, and 225-3, respectively.

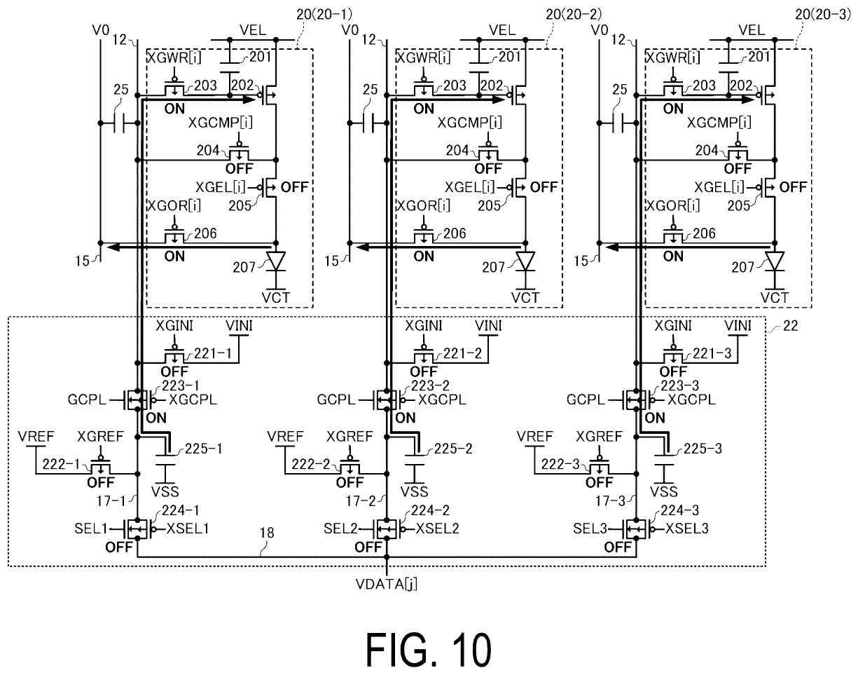

As illustrated in FIG. 5, in the horizontal scanning period 1H for the i-th row, the scanning signal XGWR[i] is at the L level in the writing period d. Further, the control signal XGOR[i] is at the L level, and the control signals XGCMP[i] and XGEL[i] are at the H level. Further, the control signals XGREF and XGINI are at the H level. Further, the control signals SEL1, SEL2, SEL3, and XGCPL are at the H level, and the control signals XSEL1, XSEL2, XSEL3, and GCPL are at the L level. Therefore, as illustrated in FIG. 10, in the writing period d, the MOSFETs 203 and 206 are on and the MOSFETs 204 and 205 are off in each of the pixel circuits 20-1, 20-2, and 20-3. Further, in the data line driving circuit 22, the MOSFETS 221-1, 221-2, 221-3, 222-1, 222-2, and 222-3 are off, the switch circuits 223-1, 223-2, and 223-3 are on, and the switch circuit 224-1, 224-2, and 224-3 are off. Therefore, in the pixel circuit 20-1, the other end of the capacitance element 201 and the gate of the MOSFET 202 are supplied with the data potential VDATA[j] held in the capacitance element 225-1, via the data transfer line 17-1, the switch circuit 223-1, the data line 12, and the MOSFET 203. Similarly, in the pixel circuit 20-2, the other end of the capacitance element 201 and the gate of the MOSFET 202 are supplied with the data potential VDATA[j] held in the capacitance element 225-2, via the data transfer line 17-2, the switch circuit 223-2, the data line 12, and the MOSFET 203. Similarly, in the pixel circuit 20-3, the other end of the capacitance element 201 and the gate of the MOSFET 203 are supplied with the data potential VDATA[j] held in the capacitance element 225-3, via the data transfer line 17-3, the switch circuit 223-3, the data line 12, and the MOSFET 203.

Here, immediately before both the MOSFET 203 of the pixel circuit 20-1 and the switch circuit 223-1 are on, the potential of the data line 12 is the potential (VEL−|Vth|), and the potential of the data transfer line 17-1 is the data potential VDATA[j]. Therefore, when both the MOSFET 203 and the switch circuit 223-1 are on, the potential of the data line 12 becomes a potential ((Cd·(VEL−|Vth |)+Cst·VDATA[j])/(Cd+Cst)) due to capacitive coupling between the capacitor 25 and the capacitance element 225-1. Note that Cd is a capacitance value of the capacitor 25, and Cst is a capacitance value of the capacitance element 225-1. The same applies to the potentials of the data lines 12 respectively coupled to the pixel circuits 20-2 and 20-3. Thereafter, when the scanning signal XGWR[j] is at the L level, in each of the pixel circuits 20-1, 20-2, and 20-3, the MOSFET 203 is off, and the potential of the gate of the MOSFET 202 is determined to be the potential ((Cd·(VEL−|Vth|)+Cst·VDATA[j])/(Cd+Cst)).

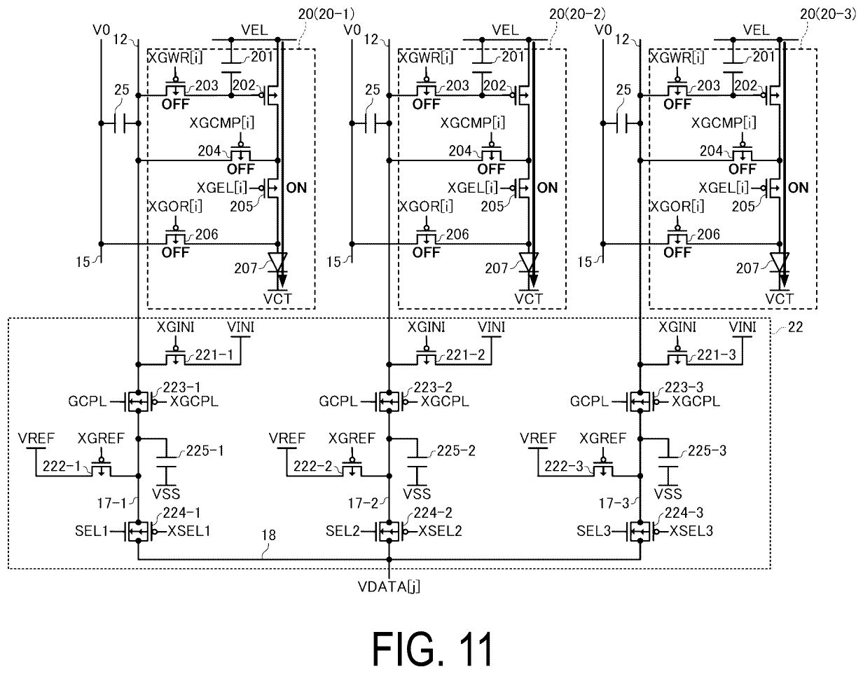

As illustrated in FIG. 5, in the horizontal scanning period 1H for the i-th row, the scanning signal XGWR[i] is at the H level in the light-emitting period e. Further, the control signal XGEL[i] is at the L level, and the control signals XGCMP[i] and XGOR[i] are at the H level. Therefore, as illustrated in FIG. 11, in the light-emitting period e, the MOSFET 205 is on and the MOSFETs 203, 204, and 206 are off in each of the pixel circuits 20-1, 20-2, and 20-3. Therefore, a current flowing from the source to the drain of the MOSFET 202 is supplied to the light-emitting element 207 via the MOSFET 205, and the light-emitting element 207 emits light. The potential of the source of the MOSFET 202 is the potential VEL and the potential of the gate of the MOSFET 202 is the potential ((Cd·(VEL−|Vth|)+Cst·VDATA[j])/(Cd+Cst)), and thus a current corresponding to the potential VDATA[j] is to be supplied to the light-emitting element 207 in a state where the threshold voltage Vth of the MOSFET 202 is compensated.

Note that as illustrated in FIG. 5, control signals XGEL[i+1], XGOR[i+1], XGCMP[i+1] and scanning signal XGWR[i+1] in the horizontal scanning period 1H for an (i+1)-th row subsequent to the horizontal scanning period 1H for the i-th row have waveforms obtained by shifting each of the control signals XGEL[i], XGOR[i], XGCMP[i] and the scanning signal XGWR[i] by a time corresponding to a cycle of the horizontal scanning period 1H.

In the first embodiment, the MOSFET 202 is an example of a “first transistor”, the MOSFET 203 is an example of a “second transistor”, the MOSFET 204 is an example of a “third transistor”, and the MOSFET 205 is an example of a “fourth transistor”. Further, each of the switch circuits 223-1, 223-2, and 223-3 is an example of a “first switch circuit”, and each of the switch circuits 224-1, 224-2, and 224-3 is an example of a “second switch circuit”. Further, the potential VINI is an example of a “first potential”. Further, the initialization period a is an example of a “first period”, the compensation period b is an example of a “second period”, the writing period d is an example of a “third period”, and the light-emitting period e is an example of a “fourth period”.

### 1-1-5. Operational Effects

As described above, in the display device 1 of the first embodiment, the potential of the gate of the MOSFET 202 is initialized to the potential VINI in the initialization period a, and the gate of the MOSFET 202 is supplied with the potential VDATA[j] in the writing period d. Then, the voltage between the gate and the source of the MOSFET 202 is set to the threshold voltage Vth in the compensation period b between the initialization period a and the writing period d, thus the gate of the MOSFET 202 is held at a potential for which the threshold voltage Vth is compensated in the writing period d. In particular, in the first transfer period c1, the second transfer period c2 and the third transfer period c3 each overlapping a part of the compensation period b, the data potentials VDATA[j] transferred from the data supply line 18 to the respective data transfer lines 17-1, 17-2, and 17-3 are held in the respective capacitance elements 225-1, 225-2, and 225-3, and in the writing period d, the gates of the MOSFETs 202 are held at the potential for which the threshold voltage Vth is compensated by coupling between the respective capacitance elements 225-1, 225-2, and 225-3 and the capacitors 25 of the data lines 12. Therefore, in the light-emitting period e, the light-emitting element 207 is supplied with a current corresponding to the potential VDATA[j] in a state in which the threshold voltage Vth of the MOSFET 202 is compensated, and thus can emit light with high accuracy. Therefore, according to the display device 1 of the first embodiment, it is not necessary to provide a coupling capacitance between the data line 12 and the pixel circuit 20, and it is possible to simplify the data line driving circuit 22 and reduce an area size.

In addition, according to the display device 1 of the first embodiment, each of the first transfer period c1, the second transfer period c2, and the third transfer period c3 overlaps a part of the compensation period b, thus it is possible to reduce a time required for data writing to the pixel circuit 20.

### 1-2. Second Embodiment

Hereinafter, in the display device 1 of a second embodiment, the same configurations as those of the first embodiment are denoted by the same reference numerals, the same descriptions as those of the first embodiment are omitted or simplified, and contents different from those of the first embodiment will be mainly described.

A perspective view of the display device 1 of the second embodiment is the same as FIG. 1 and a plan view of the display panel 2 in the second embodiment is the same as FIG. 2, thus illustration and description thereof will be omitted. In addition, a block diagram illustrating an electrical configuration of the display device 1 of the second embodiment is the same as FIG. 3, thus illustration and description thereof will be omitted. However, the display device 1 of the second embodiment is different from the first embodiment in that the data potential generating circuit 23 includes a capacitive DAC that outputs the data potential VDATA[j]. DAC is an abbreviation for Digital to Analog Converter. Further, the data potential generating circuit 23 includes the capacitive DAC, thus a configuration of the data line driving circuit 22 is also different from that of the first embodiment.

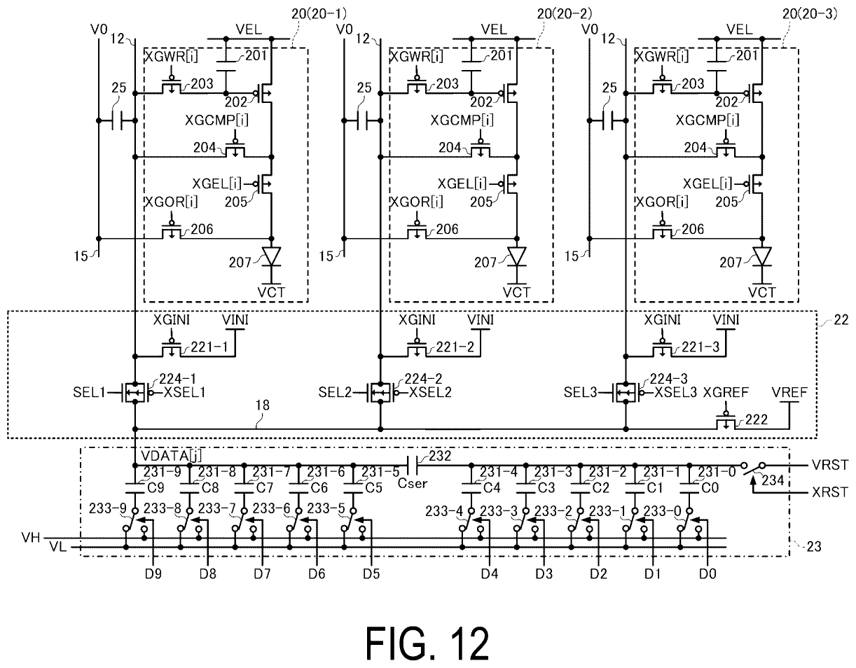

FIG. 12 is a diagram illustrating a configuration of three pixel circuits 20 corresponding to the pixel P in the i-th row and the j-th column, the j-th data line driving circuit 22, and the data potential generating circuit 23 in the display device 1 of the second embodiment. In FIG. 12, the same components as those in FIG. 4 are denoted by the same reference numerals. A configuration of the pixel circuit 20 is the same as that in FIG. 4, and thus description thereof is omitted.

As illustrated in FIG. 12, the data line driving circuit 22 in the second embodiment includes the P-channel type MOSFETs 221-1, 221-2, 221-3, the switch circuits 224-1, 224-2, and 224-3 as in the first embodiment, but does not include the switch circuits 223-1, 223-2, 223-3, the capacitance elements 225-1, 225-2, and 225-3 unlike the first embodiment. In addition, the data line driving circuit 22 in the second embodiment includes a P-channel type MOSFET 222 instead of the P-channel type MOSFETs 222-1, 222-2, and 222-3.

The source of the MOSFET 221-1 is supplied with the potential VINI from the control circuit 3, and the drain of the MOSFET 221-1 is coupled to the data line 12 coupled to the pixel circuit 20-1. The input terminal of the switch circuit 224-1 is coupled to the data supply line 18, and the output terminal of the switch circuit 224-1 is coupled to the data line 12 coupled to the pixel circuit 20-1.

Similarly, the source of the MOSFET 221-2 is supplied with the potential VINI from the control circuit 3, and the drain of the MOSFET 221-2 is coupled to the data line 12 coupled to the pixel circuit 20-2. The input terminal of the switch circuit 224-2 is coupled to the data supply line 18, and the output terminal of the switch circuit 224-2 is coupled to the data line 12 coupled to the pixel circuit 20-2.

Similarly, the source of the MOSFET 221-3 is supplied with the potential VINI from the control circuit 3, and the drain of the MOSFET 221-3 is coupled to the data line 12 coupled to the pixel circuit 20-3. The input terminal of the switch circuit 224-3 is coupled to the data supply line 18, and the output terminal of the switch circuit 224-3 is coupled to the data line 12 coupled to the pixel circuit 20-3.

A source of the MOSFET 222 is supplied with the potential VREF from the control circuit 3, and a drain of the MOSFET 222 is coupled to the data supply line 18.

The data supply line 18 is supplied with the data potential VDATA[j] generated by the j-th data potential generating circuit 23.

The control signal XGINI is input from the control circuit 3 to the gate of each of the MOSFETS 221-1, 221-2, and 221-3. The control signal XGREF is input from the control circuit 3 to a gate of the MOSFET 222.

The control signal SEL1 is input from the control circuit 3 to the first control terminal of the switch circuit 224-1, and the control signal XSEL1 is input from the control circuit 3 to the second control terminal of the switch circuit 224-1. The control signal SEL1 and the control signal XSEL1 are digital signals for which logic levels are inverted from each other.

The control signal SEL2 is input from the control circuit 3 to the first control terminal of the switch circuit 224-2, and the control signal XSEL2 is input from the control circuit 3 to the second control terminal of the switch circuit 224-2. The control signal SEL2 and the control signal XSEL2 are digital signals for which logic levels are inverted from each other.

The control signal SEL3 is input from the control circuit 3 to the first control terminal of the switch circuit 224-3, and the control signal XSEL3 is input from the control circuit 3 to the second control terminal of the switch circuit 224-3. The control signal SEL3 and the control signal XSEL3 are digital signals for which logic levels are inverted from each other.

The MOSFET 221-1 controls supply of the potential VINI to the data line 12 coupled to the pixel circuit 20-1. The MOSFET 221-2 controls supply of the potential VINI to the data line 12 coupled to the pixel circuit 20-2. The MOSFET 221-3 controls supply of the potential VINI to the data line 12 coupled to the pixel circuit 20-3. To be more specific, when the control signal XGINI is at the L level, the MOSFET 221-1 is on and the data line 12 coupled to the pixel circuit 20-1 is supplied with the potential VINI, the MOSFET 221-2 is on and the data line 12 coupled to the pixel circuit 20-2 is supplied with the potential VINI, and the MOSFET 221-3 is on and the data-line 12 coupled to the pixel circuit 20-3 is supplied with the potential VINI. Further, when the control signal XGINI is at the H level, the MOSFET 221-1 is off and the data line 12 coupled to the pixel circuit 20-1 is not supplied with the potential VINI, the MOSFET 221-2 is off and the data line 12 coupled to the pixel circuit 20-2 is not supplied with the potential VINI, and the MOSFET 221-3 is off and the data-line 12 coupled to the pixel circuit 20-3 is not supplied with the potential VINI.

The MOSFET 222 controls supply of the potential VREF to the data supply line 18. To be more specific, when the control signal XGREF is at the L level, the MOSFET 222 is on and the data supply line 18 is supplied with the potential VREF, and when the control signal XGREF is at the H level, the MOSFET 222 is off and the data supply line 18 is not supplied with the potential VREF.

The switch circuit 224-1 controls electrical coupling between the data line 12 coupled to the pixel circuit 20-1 and the data supply line 18. The switch circuit 224-2 controls electrical coupling between the data line 12 coupled to the pixel circuit 20-2 and the data supply line 18. The switch circuit 224-3 controls electrical coupling between the data line 12 coupled to the pixel circuit 20-3 and the data supply line 18. To be more specific, when the control signals SEL1 and XSEL1 are at the H level and the L level, respectively, the switch circuit 224-1 is on and the data line 12 coupled to the pixel circuit 20-1 and the data supply line 18 are electrically coupled to each other, and when the control signals SEL1 and XSEL1 are at the L level and the H level, respectively, the switch circuit 224-1 is off and the data line 12 coupled to the pixel circuit 20-1 and the data supply line 18 are electrically disconnected from each other. Further, when the control signals SEL2 and XSEL2 are at the H level and the L level, respectively, the switch circuit 224-2 is on and the data line 12 coupled to the pixel circuit 20-2 and the data supply line 18 are electrically coupled to each other, and when the control signals SEL2 and XSEL2 are at the L level and the H level, respectively, the switch circuit 224-2 is off and the data line 12 coupled to the pixel circuit 20-2 and the data supply line 18 are electrically disconnected from each other. Further, when the control signals SEL3 and XSEL3 are at the H level and the L level, respectively, the switch circuit 224-3 is on and the data line 12 coupled to the pixel circuit 20-3 and the data supply line 18 are electrically coupled to each other, and when the control signals SEL3 and XSEL3 are at the L level and the H level, respectively, the switch circuit 224-3 is off and the data line 12 coupled to the pixel circuit 20-3 and the data supply line 18 are electrically disconnected from each other.

Then, when the data line 12 coupled to the pixel circuit 20-1 and the data supply line 18 are electrically coupled to each other by the switch circuit 224-1, the data potential VDATA[j] is transferred from the data supply line 18 to the data line 12. Similarly, when the data line 12 coupled to the pixel circuit 20-2 and the data supply line 18 are electrically coupled to each other by the switch circuit 224-2, the data potential VDATA[j] is transferred from the data supply line 18 to the data line 12. Similarly, when the data line 12 coupled to the pixel circuit 20-3 and the data supply line 18 are electrically coupled to each other by the switch circuit 224-3, the data potential VDATA[j] is transferred from the data supply line 18 to the data line 12.

Note that the control signals XGINI, SEL1, XSEL1, SEL2, XSEL2, SEL3, and XSEL3 are input in common to the n data line driving circuits 22.

As illustrated in FIG. 12, 10-bit image data VIDX which is switched to R data, B data, and G data of m pixels P in the j-th column in a time division manner is input from the control circuit 3 to the j-th data potential generating circuit 23. In FIG. 12, D9, D8, D7, D6, D5, D4, D3, D2, D1, and D0 are denoted in order from a highest bit of the image data VIDX.

The data potential generating circuit 23 includes the capacitive DAC including capacitance elements 231-0 to 231-9, 232, switch circuits 233-0 to 233-9, and 234.

One end of each of the capacitance elements 231-0 to 231-4 and an output terminal of the switch circuit 234 are coupled to one end of the capacitance element 232. One end of each of the capacitance elements 231-5 to 231-9 is coupled to another end of the capacitance element 232 and the data supply line 18. Another ends of the capacitance elements 231-0 to 231-9 are respectively coupled to output terminals of the respective switch circuits 233-0 to 233-9. A first input terminal of each of the switch circuits 233-0 to 233-9 is supplied with a potential VL from the control circuit 3, and a second input terminal of each of the switch circuits 233-0 to 233-9 is supplied with a potential VH higher than the potential VL from the control circuit 3. The bits D0 to D9 of the image data VIDX are respectively input from the control circuit 3 to control terminals of the respective switch circuits 233-0 to 233-9. In a switch circuit 233-k, a first input terminal and an output terminal are electrically coupled to each other when a bit Dk is at the L level, and a second input terminal and the output terminal are electrically coupled to each other when the bit Dk is at the H level. That is, the switch circuit 233-k outputs the potential VL when the bit Dk is at the L level, and outputs the potential VH when the bit Dk is at the H level. k is an integer from 0 to 9.

When a capacitance value of the capacitance element 231-k is Ck, C0:C1:C2:C3:C4:C5:C6:C7:C8:C9=1:2:4:8:16:1:2:4:8:16, for example. Further, a capacitance value Cser of the capacitance element 232 may be the same as C0 and C5. Note that errors are allowed to some extent for the capacitance values C0 to C9, and Cser as long as linearity is maintained between the value of the 10-bit image data VIDX that is input and the data potential VDATA[j] that is output.

An input terminal of the switch circuit 234 is supplied with a potential VRST from the control circuit 3, and a control signal XRST is input from the control circuit 3 to a control terminal of the switch circuit 234. In the switch circuit 234, when the control signal XRST is at the L level, the input terminal and the output terminal are electrically coupled to each other, and when the control signal XRST is at the H level, the input terminal and the output terminal are not electrically coupled to each other. Therefore, when the control signal XRST is at the L level, the one end of each of the capacitance elements 231-0 to 231-4 and one end of the capacitance element 232 is supplied with the potential VRST. Note that one ends of the capacitance elements 231-5 to 231-9 and the other end of the capacitance element 232 are coupled to the data supply line 18, thus is supplied with the potential VREF when the control signal XGREF is at the L level. Therefore, when the control signal XRST and the control signal XGREF are both at the L level, charges accumulated in the capacitance elements 231-0 to 231-9, and 232 are initialized.

On the other hand, when both the control signal XRST and the control signal XGREF are at the H level, charges corresponding to logic levels of the respective bits D0 to D9 are accumulated in the respective capacitance elements 231-0 to 231-9. The one end of each of the capacitance elements 231-0 to 231-4 is coupled to the one end of the capacitance element 232, thus the one end of the capacitance element 232 has a potential corresponding to the logic levels of the respective bits D0 to D4. In addition, one end of each of the capacitance elements 231-5 to 231-9 is coupled to the other end of the capacitance element 232, thus the other end of the capacitance element 232 has a potential obtained by shifting the potential according to the logic levels of the respective bits D5 to D9 according to the potential of the one end of the capacitance element 232. Therefore, the potential of the other end of the capacitance element 232 changes linearly with respect to the bits D9 to D0, and is supplied to the data supply line 18 as the data potential VDATA[j].

As described above, under the control of the control circuit 3, the j-th data potential generating circuit 23 acquires each of the R data, the B data, and the G data of the m pixels P in the j-th column included in the image data VIDX output from the control circuit 3 at timing designated by the control circuit 3, performs D/A conversion, and generates the data potentials VDATA[j] to be respectively supplied to the data lines 12 in the (3j−2)-th column, the (3j−1)-th column, and the 3j-th column. Therefore, the data potential VDATA[j] is switched in a time division manner at times when the R data, the B data, or the G data are written to the 3m pixel circuits 20 corresponding to the m pixels P in the j-th column.

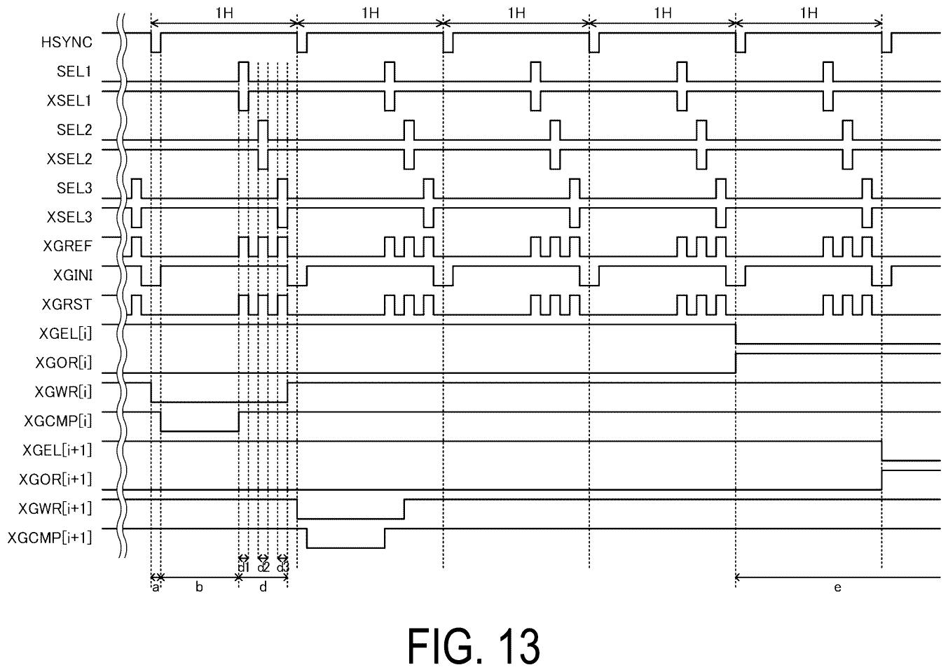

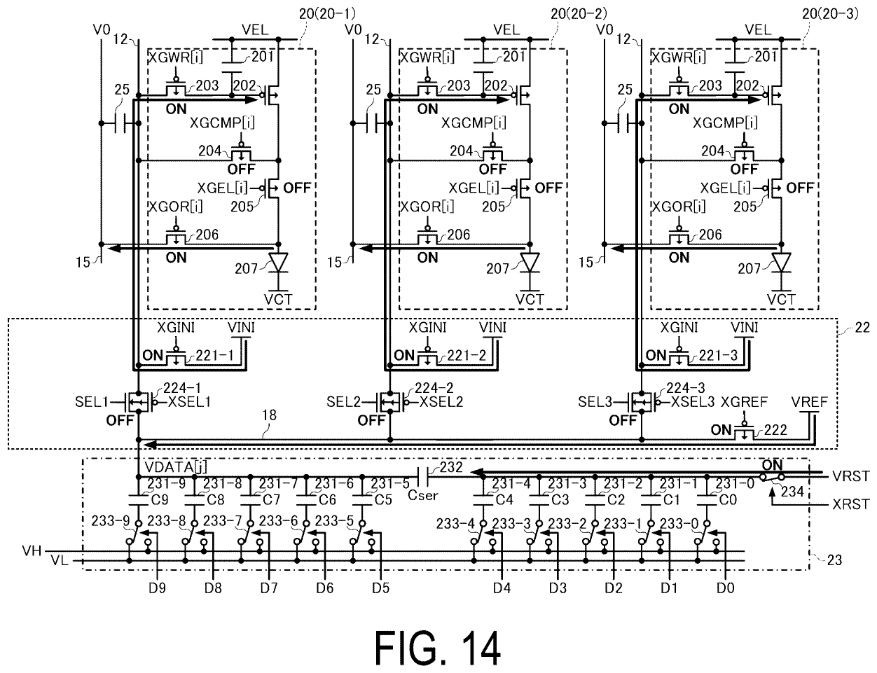

Next, operation of the display device 1 of the second embodiment will be described with reference to FIGS. 13 to 19. FIG. 13 is a timing chart illustrating an example of waveforms of various signals in the display device 1 of the second embodiment. Further, FIGS. 14 to 19 are diagrams obtained by adding ON/OFF of the MOSFETs and the switch circuits in each period and supply paths of various potentials to FIG. 12. Note that description will not be made of operation similar to that of the display device 1 of the first embodiment.

As illustrated in FIG. 13, in the horizontal scanning period 1H for the i-th row, the scanning line driving circuit 21 commonly outputs the control signals XGEL[i], XGOR[i], and XGCMP[i] and the scanning signal XGWR[i] to the 3n pixel circuits 20 corresponding to the n pixels P in the i-th row. Further, the control circuit 3 commonly outputs the control signals XGINI, XGREF, SEL1, XSEL1, SEL2, XSEL2, SEL3, and XSEL3 to the n data line driving circuits 22. Note that FIG. 13 is a timing chart focusing on the horizontal scanning period 1H for the i-th row after the horizontal scanning periods 1H for the first to (i−1)-th rows ended.

As illustrated in FIG. 13, the horizontal scanning period 1H for the i-th row includes the initialization period a, the compensation period b after the initialization period a, and the writing period d after the compensation period b. Further, the writing period d includes a first writing period d1, a second writing period d2, and a third writing period d3. Then, after the writing period d, after a while, the light-emitting period e is reached, and after a period of one frame elapses, the horizontal scanning period 1H for the i-th row is reached again.

As illustrated in FIG. 13, in the horizontal scanning period 1H for the i-th row, the scanning signal XGWR[i] is at the L level, in the initialization period a. Further, the control signal XGOR[i] is at the L level, and the control signals XGEL[i] and XGCMP[i] are at the H level. Further, the control signals XGREF, XGINI, and XRST are at the L level. Further, the control signals SEL1, SEL2, and SEL3 are at the L level, and the control signals XSEL1, XSEL2, and XSEL3 are at the H level. Therefore, as illustrated in FIG. 14, in the initialization period a, the MOSFETs 203 and 206 are on and the

MOSFETs 204 and 205 are off in each of the pixel circuits 20-1, 20-2, and 20-3. Further, in the data line driving circuit 22, the MOSFETS 221-1, 221-2, 221-3, and 222 are on, and the switch circuits 224-1, 224-2, and 224-3 are off. Therefore, in each of the pixel circuits 20-1, 20-2, and 20-3, the gate of the MOSFET 202 and the other end of the capacitance element 201 are supplied with the potential VINI via the data line 12. Further, the anode of the light-emitting element 207 is supplied with the potential V0 via the power supply line 15. That is, the potentials of the data line 12, the gate of the MOSFET 202, and the other end of the capacitance element 201 are initialized to the potential VINI, and the potential of the anode of the light-emitting element 207 is initialized to the potential V0. In addition, in the data line driving circuit 22, the data supply line 18 which is an output node of the capacitive DAC, one end of each of the capacitance elements 231-5 to 231-9, and the other end of the capacitance element 232 are supplied with the predetermined potential VREF, the one end of each of the capacitance elements 231-0 to 231-4, and the one end of the capacitance element 232 are supplied with the potential VRST, and charges accumulated in the capacitance elements 231-0 to 231-9, and 232 are initialized.

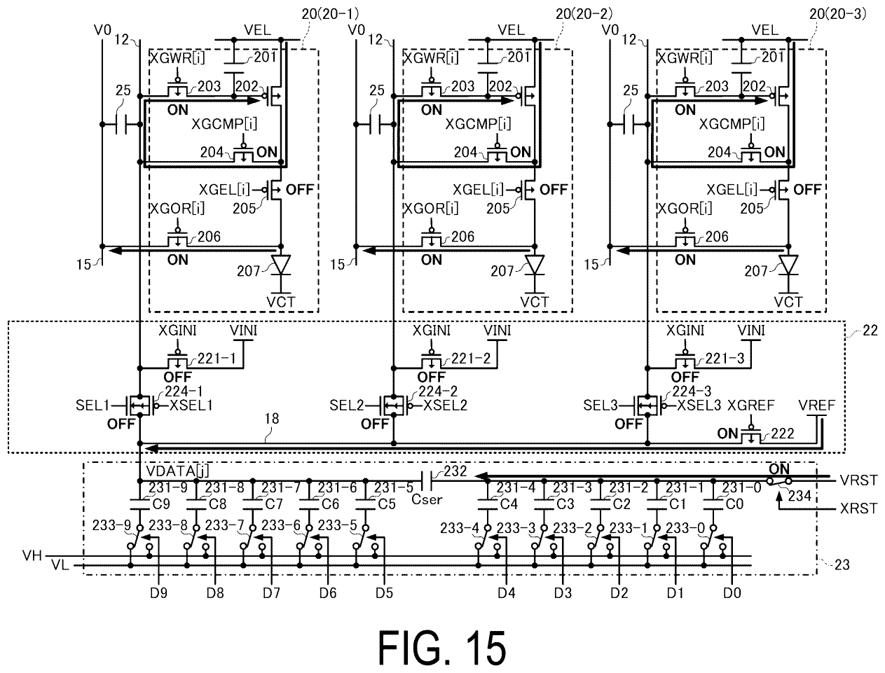

As illustrated in FIG. 13, in the horizontal scanning period 1H for the i-th row, the scanning signal XGWR[i] is at the L level in the compensation period b. Further, the control signals XGOR[i] and XGCMP[i] are at the L level, and the control signal XGEL[i] is at the H level. Further, the control signal XGINI is at the H level, and the control signals XGREF and XRST are at the L level. Further, the control signals SEL1, SEL2, and SEL3 are at the L level, and the control signals XSEL1, XSEL2, and XSEL3 are at the H level. Therefore, as illustrated in FIG. 15, in the compensation period b, the MOSFETs 203, 204, and 206 are on and the MOSFET 205 is off in each of the pixel circuits 20-1, 20-2, and 20-3. Further, in the data line driving circuit 22, the MOSFETS 221-1, 221-2, and 221-3 are off, the MOSFET 222 is on, and the switch circuits 224-1, 224-2, and 224-3 are off. Therefore, in each of the pixel circuits 20-1, 20-2, and 20-3, a current flows from the power supply line at the potential VEL to the gate of the MOSFET 202 via the MOSFETS 202, 204, and 205, and the potentials of the data line 12, the gate of the MOSFET 202 and the other end of the capacitance element 201 rise from the potential VINI. At this time, since the MOSFET 202 is in the state in which the gate and the drain are coupled to each other, that is, in the diode-coupled state, the voltage between the gate and the source in the MOSFET 202 converges to the threshold voltage Vth of the MOSFET 202. Since the MOSFET 202 is of the P-channel type, the threshold voltage Vth is a negative voltage. Since the source of the MOSFET 202 is supplied with the potential VEL, the potentials of the data line 12, the gate of the MOSFET 202, and the other end of the capacitance element 201 converge to a potential (VEL−|Vth|). Further, the potential of the anode of the light-emitting element 207 is maintained at the potential V0. In addition, in the data line driving circuit 22, the data supply line 18 which is the output node of the capacitive DAC is supplied with the predetermined potential VREF, and the initialization of the charges accumulated in the capacitance elements 231-0 to 231-9, and 232 is continued.

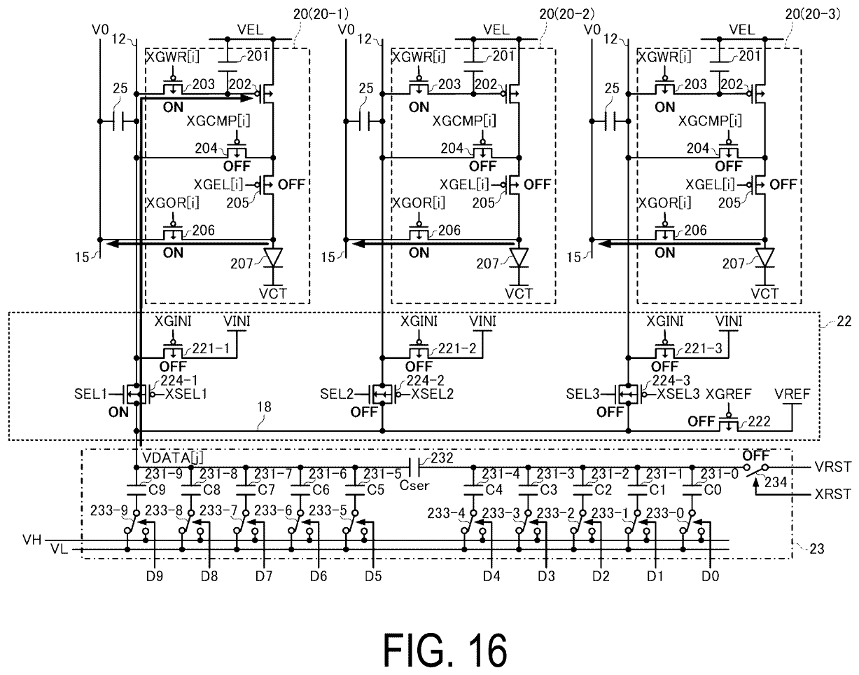

As illustrated in FIG. 13, in the horizontal scanning period 1H for the i-th row, the scanning signal XGWR[i] is at the L level in the writing period d. Further, the control signal XGOR[i] is at the L level, and the control signals XGCMP[i] and XGEL[i] are at the H level. Further, the control signal XGINI is at the H level. Therefore, as illustrated in FIGS. 16, 17, and 18, in the writing period d, the MOSFETs 203 and 206 are on and the MOSFETs 204 and 205 are off in each of the pixel circuits 20-1, 20-2, and 20-3.

In addition, in the first write period dl included in the writing period d, the control signals XGREF and XRST are at the H level. Further, the control signals SEL1, XSEL2, and XSEL3 are at the H level, and the control signals XSEL1, SEL2, and SEL3 are at the L level. Therefore, as illustrated in FIG. 16, the MOSFET 222 is off, and the data potential generating circuit 23 generates the data potential VDATA[j] and outputs the data potential VDATA[j] to the data supply line 18. Then, the data potential VDATA[j] is transferred from the data supply line 18 to the data line 12 coupled to the pixel circuit 20-1 via the switch circuit 224-1, and is supplied to the other end of the capacitance element 201 and the gate of the MOSFET 202 via the MOSFET 203 in the pixel circuit 20-1.

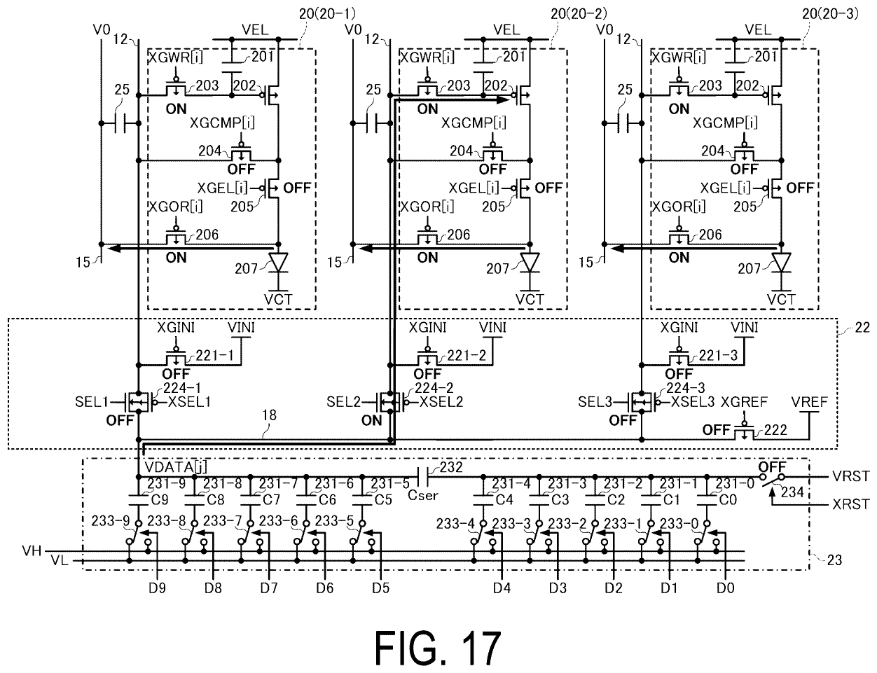

In addition, in the second write period d2 included in the writing period d, the control signals XGREF and XRST are at the H level. Further, the control signals XSEL1, SEL2, and XSEL3 are at the H level, and the control signals SEL1, XSEL2, and SEL3 are at the L level. Therefore, as illustrated in FIG. 17, the MOSFET 222 is off, and the data potential generating circuit 23 generates the data potential VDATA[j] and outputs the data potential VDATA[j] to the data supply line 18. Then, the data potential VDATA[j] is transferred from the data supply line 18 to the data line 12 coupled to the pixel circuit 20-2 via the switch circuit 224-2, and is supplied to the other end of the capacitance element 201 and the gate of the MOSFET 202 via the MOSFET 203 in the pixel circuit 20-2.

In addition, in the third write period d3 included in

the writing period d, the control signals XGREF and XRST are at the H level. Further, the control signals XSEL1, XSEL2, and

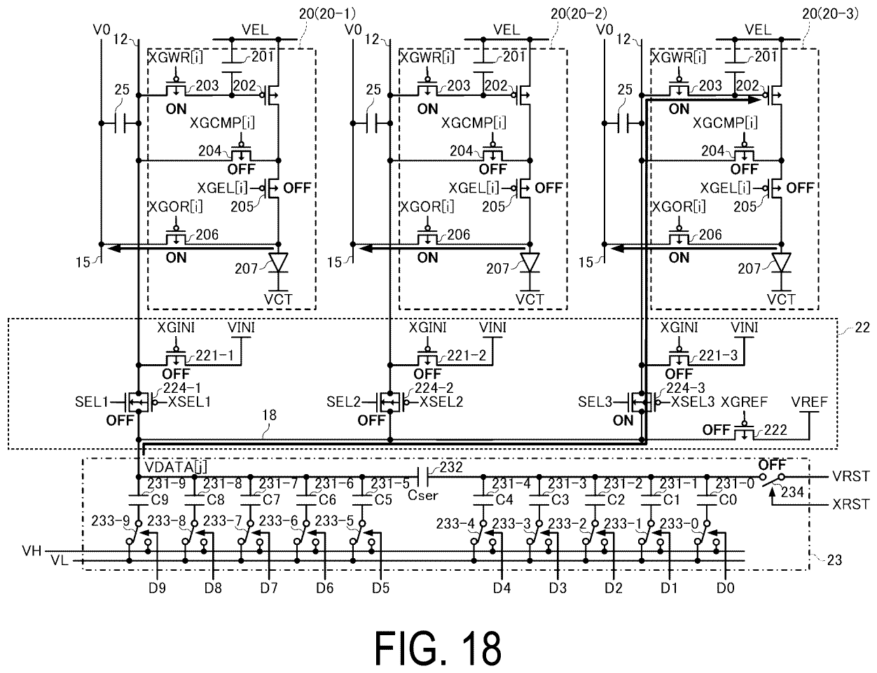

SEL3 are at the H level, and the control signals SEL1, SEL2, and XSEL3 are at the L level. Therefore, as illustrated in FIG. 18, the MOSFET 222 is off, and the data potential generating circuit 23 generates the data potential VDATA[j] and outputs the data potential VDATA[j] to the data supply line 18. Then, the data potential VDATA[j] is transferred from the data supply line 18 to the data line 12 coupled to the pixel circuit 20-3 via the switch circuit 224-3, and is supplied to the other end of the capacitance element 201 and the gate of the MOSFET 202 via the MOSFET 203 in the pixel circuit 20-3.

Note that immediately before each of the first writing period d1, the second writing period d2, and the third writing period d3, the control signals XGREF and XRST are at the L level, the MOSFET 222 is on, and the charges accumulated in the capacitance elements 231-0 to 231-9, and 232 are initialized.

Here, immediately before both the MOSFET 203 of the pixel circuit 20-1 and the switch circuit 224-1 are on, the potential of the data line 12 is the potential (VEL−|Vth|), and when both the MOSFET 203 and the switch circuit 224-1 are on, the potential of the data supply line 18 becomes the data potential VDATA[j]. Therefore, the potential of the data line 12 becomes the potential ((Cd·(VEL−|Vth|)+Cst·VDATA[j])/(Cd+Cst)) by capacitive coupling between the capacitor 25 and the capacitance elements 231-0 to 231-9, and 232 of the data potential generating circuit 23. Note that Cd is the capacitance value of the capacitor 25, and Cst is a combined capacitance value of the capacitance elements 231-0 to 231-9, and 232. The same applies to the potentials of the data lines 12 respectively coupled to the pixel circuits 20-2 and 20-3. Thereafter, when the scanning signal XGWR[j] is at the L level, in each of the pixel circuits 20-1, 20-2, and 20-3, the MOSFET 203 is off, and the potential of the gate of the MOSFET 202 is determined to be the potential ((Cd·(VEL·|Vth|)+Cst·VDATA[j])/(Cd+Cst)).

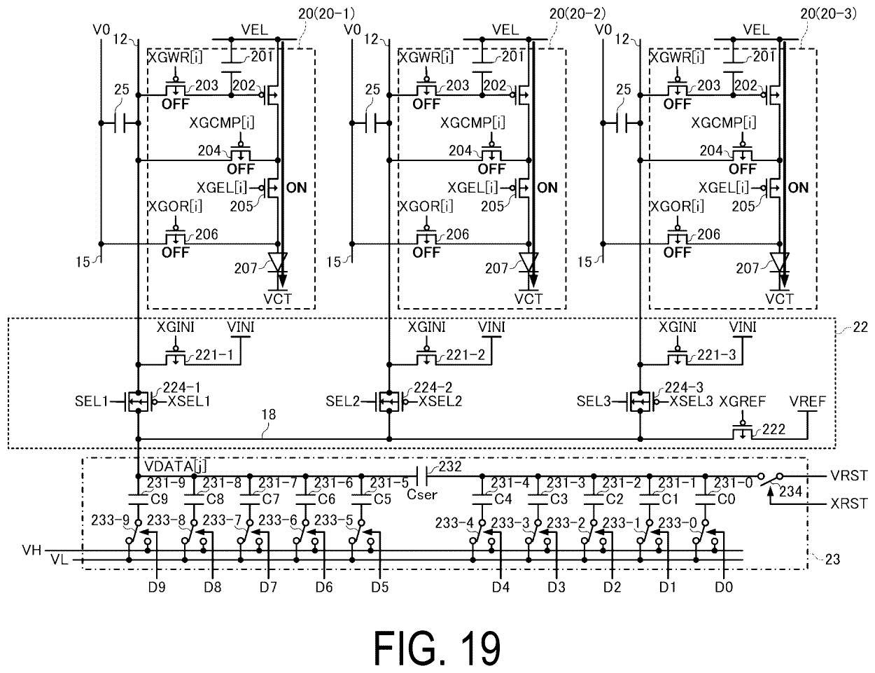

As illustrated in FIG. 13, in the horizontal scanning period 1H for the i-th row, the scanning signal XGWR[i] is at the H level in the light-emitting period e. Further, the control signal XGEL[i] is at the L level, and the control signals XGCMP[i] and XGOR[i] are at the H level. Therefore, as illustrated in FIG. 19, in the light-emitting period e, the MOSFET 205 is on and the MOSFETs 203, 204, and 206 are off in each of the pixel circuits 20-1, 20-2, and 20-3. Therefore, a current flowing from the source to the drain of the MOSFET 202 is supplied to the light-emitting element 207 via the MOSFET 205, and the light-emitting element 207 emits light. The potential of the source of the MOSFET 202 is the potential VEL and the potential of the gate of the MOSFET 202 is the potential ((Cd·(VEL−|Vth|)+Cst·VDATA[j])/(Cd+Cst)), and thus a current corresponding to the potential VDATA[j] is to be supplied to the light-emitting element 207 in a state where the threshold voltage Vth of the MOSFET 202 is compensated.

Note that as illustrated in FIG. 13, control signals XGEL[i+1], XGOR[i+1], XGCMP[i+1] and scanning signal XGWR[i+1] in the horizontal scanning period 1H for the (i+1)-th row subsequent to the horizontal scanning period 1H for the i-th row have waveforms obtained by shifting each of the control signals XGEL[i], XGOR[i], XGCMP[i] and the scanning signal XGWR[i] by the time corresponding to the cycle of the horizontal scanning period 1H.

In the second embodiment, the MOSFET 202 is an example of a “first transistor”, the MOSFET 203 is an example of a “second transistor”, the MOSFET 204 is an example of a “third transistor”, and the MOSFET 205 is an example of a “fourth transistor”. Further, the potential VINI is an example of a “first potential”, and the potential VREF is an example of a “second potential”. Further, the initialization period a is an example of a “first period”, the compensation period b is an example of a “second period”, the writing period d is an example of a “third period”, and the light-emitting period e is an example of a “fourth period”.

As described above, in the display device 1 of the second embodiment, the potential of the gate of the MOSFET 202 is initialized to the potential VINI in the initialization period a, and the gate of the MOSFET 202 is supplied with the potential VDATA[j] in the writing period d. Then, the voltage between the gate and the source of the MOSFET 202 is set to the threshold voltage Vth in the compensation period b between the initialization period a and the writing period d, thus the gate of the MOSFET 202 is held at a potential for which the threshold voltage Vth is compensated in the writing period d. To be more specific, in the first writing period d1, the second writing period d2, and the third writing period d3 included in the writing period d, the gate of the MOSFET 202 is held at a potential for which the threshold voltage Vth is compensated by coupling between a capacitance of the capacitive DAC in which an output node is coupled to the data supply line 18 and the capacitance 25 of the data line 12. Therefore, in the light-emitting period e, the light-emitting element 207 is supplied with the current corresponding to the potential VDATA[j] in the state in which the threshold voltage Vth of the MOSFET 202 is compensated, and thus can emit light with high accuracy. Therefore, according to the display device 1 of the second embodiment, it is not necessary to provide a coupling capacitance between the data line 12 and the pixel circuit 20, and it is possible to simplify the data line driving circuit 22 and reduce the area size.

In addition, according to the display device 1 of the second embodiment, the capacitive DAC performs D/A conversion in the first writing period d1, the second writing period d2, and the third writing period d3 after the data supply line 18 which is the output node of the capacitive DAC is initialized to the potential VREF, thus a time required for the D/A conversion is shortened.

In addition, according to the display device 1 of the second embodiment, the capacitive DAC that generates the data potential VDATA[j] is coupled to the data supply line 18, thus it is not necessary for the data supply line 18 to be provided with a capacitance element for holding data, which is advantageous for miniaturization.

### 2. Electronic Apparatus

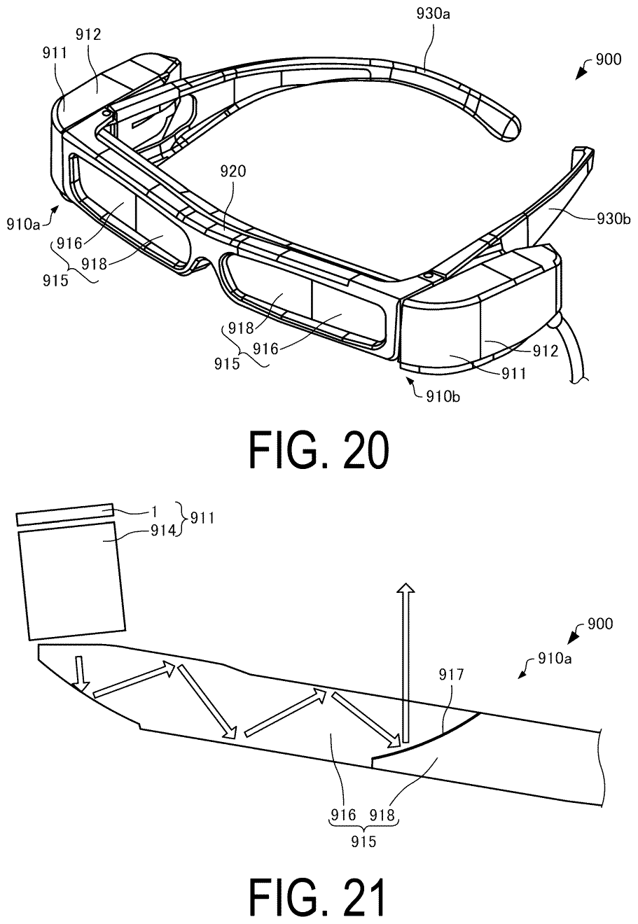

A head-mounted display will be described as an example of an electronic apparatus of the embodiment. FIG. 20 is a perspective view schematically illustrating a head-mounted display 900 as an example of the electronic apparatus of the embodiment.

As illustrated in FIG. 20, the head-mounted display 900 is a head-mounted device that has an outer appearance of an eyewear. The head-mounted display 900 is mounted on the head of a viewer. The viewer is a user who uses the head-mounted display 900. The head-mounted display 900 allows the viewer to visually recognize video light of a virtual image and to visually recognize an external image in a see-through manner.

The head-mounted display 900 includes, for example, a first display unit 910a, a second display unit 910b, a frame 920, a first temple 930a, and a second temple 930b.

The first display unit 910a and the second display unit 910b display images. Specifically, the first display unit 910a displays a virtual image for the right eye of the viewer. The second display unit 910b displays a virtual image for the left eye of the viewer. The display units 910a and 910b include, for example, an image forming device 911 and a light-guiding device 915.

The image forming device 911 generates image light. The image forming device 911 includes, for example, an optical system such as a light source and a projection device, and an external member 912. The external member 912 accommodates a light source and a projection device.

The light-guiding device 915 covers the front of the eyes of the viewer. The light-guiding device 915 guides the video light formed by the image forming device 911 and allows the viewer to visually recognize external light and the video light in an overlapping manner.

The frame 920 supports the first display unit 910a and the second display unit 910b. For example, the frame 920 surrounds the display units 910a and 910b. In the example illustrated in the drawing, the image forming device 911 of the first display unit 910a is attached to one end portion of the frame 920. The image forming device 911 of the second display unit 910b is attached to an other end portion of the frame 920.

The first temple 930a and the second temple 930b extend from the frame 920. In the example illustrated in the drawing, the first temple 930a extends from one end portion of the frame 920. The second temple 930b extends from another end portion of the frame 920.

The first temple 930a and the second temple 930b are put on the ears of the viewer when the head-mounted display 900 is worn by the viewer. The head of the viewer is positioned between the temples 930a and 930b.

FIG. 21 is a diagram schematically illustrating the image forming device 911 and the light-guiding device 915 of the first display unit 910a of the head-mounted display 900. The first display unit 910a and the second display unit 910b have basically the same configuration. Thus, the following description of the first display unit 910a can be applied to the second display unit 910b.

As illustrated in FIG. 21, for example, the image

forming device 911 includes the display device 1 as a light source and a projection device 914 for image formation.

The projection device 914 projects, toward the light-guiding device 915, the video light output from the display device 1. The projection device 914 is, for example, a projection lens. As the lens constituting the projection device 914, a lens having an axially symmetric surface as a lens surface may be used.

The light-guiding device 915 is accurately positioned with respect to the projection device 914, for example, by being screwed to a lens barrel of the projection device 914. The light-guiding device 915 includes, for example, a video light-guiding member 916 that guides the video light and a see-through member 918 for see-through view.

The video light emitted from the projection device 914 is incident on the video light-guiding member 916. The video light-guiding member 916 is a prism that guides the video light toward the eyes of the viewer. The video light incident on the video light-guiding member 916 is repeatedly reflected on an inner surface of the video light-guiding member 916, and is then reflected by a reflective layer 917 to be emitted from the video light-guiding member 916. The video light emitted from the video light-guiding member 916 reaches the eyes of the viewer. The reflective layer 917 is constituted by, for example, a metal or a dielectric multilayer film. The reflective layer 917 may be a half mirror.

The see-through member 918 is adjacent to the video light-guiding member 916. The see-through member 918 is fixed to the video light-guiding member 916. An outer surface of the see-through member 918 is continuous with, for example, an outer surface of the video light-guiding member 916. The viewer sees external light through the see-through member 918. The video light-guiding member 916 also has a function of making the viewer see external light therethrough, in addition to the function of guiding video light. The head-mounted display 900 may be configured not to allow the viewer to see external light therethrough.

According to the electronic apparatus of the embodiment, the display device 1 in which the circuit for driving the pixel circuit 20 is simplified and the area size is reduced is included, and thus miniaturization is easy.

Note that the electronic apparatus including the display device 1 is not limited to the head-mounted display, and may be, for example, an EVF, a projector, a wearable display such as a smart watch, or an in-vehicle head-up display. EVF is an abbreviation for Electronic View Finder.

The present disclosure is not limited to the embodiment, and various modifications may be made within the scope of the present disclosure.

Each embodiment and each modification example described above are merely examples, and are not intended as limiting. For example, each embodiment and each modification example can also be combined together as appropriate.

The present disclosure includes configurations that are substantially identical to the configurations described in the embodiment, for example, configurations with identical functions, methods and results, or with identical advantages and effects. Also, the present disclosure includes configurations obtained by replacing non-essential portions of the configurations described in the embodiment. In addition, the present disclosure also includes configurations that achieve the same effects as the configurations described in the embodiments or configurations that can achieve the same advantages. Further, the present disclosure includes configurations obtained by adding known techniques to the configurations described in the embodiment.

The following contents are derived from the embodiment and the modification examples described above.

An aspect of a display device includes
a scanning line,
a data line,
a pixel circuit provided corresponding to the scanning line and the data line, and
a data potential generating circuit configured to generate a data potential, wherein
the pixel circuit includes a first transistor, a second transistor, a third transistor, a fourth transistor, and a light-emitting element,
the first transistor supplies a current in accordance with a voltage between a gate and a source to the light-emitting element,
the second transistor controls electrical coupling between the data line and the gate of the first transistor in accordance with a potential of the scanning line,
the third transistor controls electrical coupling between the data line and a drain of the first transistor,
the fourth transistor controls electrical coupling between the light-emitting element and the drain of the first transistor,
in a first period,
the second transistor is on, the third transistor and the fourth transistor are off, and the gate of the first transistor is supplied with a predetermined first potential via the data line,
in a second period after the first period,
the second transistor and the third transistor are on, the fourth transistor is off, and the data line and the gate and the drain of the first transistor are electrically coupled to each other,
in a third period after the second period,
the second transistor is on, the third transistor and the fourth transistor are off, and the gate of the first transistor is supplied with the data potential via the data line and the second transistor.

In the display device, the potential of the gate of the first transistor is initialized to the first potential in the first period, and the gate of the first transistor is supplied with the data potential in the third period. Then, the voltage between the gate and the source of the first transistor is set to a threshold voltage in the second period between the first period and the third period, thus the gate of the first transistor is held at a potential for which the threshold voltage is compensated in the third period. For this reason, the light-emitting element is supplied with a current corresponding to the data potential in a state where the threshold potential of the first transistor is compensated, thus can emit light with high accuracy. Therefore, according to the display device, it is not necessary to provide a coupling capacitance between the data line and the pixel circuit, and it is possible to simplify a circuit for driving the pixel circuit and reduce an area size.

In an aspect of the display device,
the data potential generating circuit may include a capacitive DAC that outputs the data potential.

In an aspect of the display device,
an output node of the capacitive DAC may be supplied with a predetermined second potential in the second period.

According to the display device, the capacitive DAC performs D/A conversion in the third period after the output node of the capacitive DAC is initialized to the second potential in the second period, thus a time required for the D/A conversion is shortened.

An aspect of the display device may include
a data supply line to which the data potential generated by the data potential generating circuit is supplied, and
a switch circuit configured to control electrical coupling between the data line and the data supply line, wherein
in the first period and the second period, the switch circuit may be off, and
in the third period, the switch circuit may be on, and the data potential output from the data potential generating circuit may be transferred from the data supply line to the data line.

According to the display device, in the third period, the gate of the first transistor is held at the potential for which the threshold voltage thereof is compensated by coupling between a capacitance of the capacitive DAC coupled to the data supply line and a capacitance of the data line, and thus the light-emitting element can emit light with high accuracy thereafter. In addition, according to the display device, the capacitive DAC that generates the data potential is coupled to the data supply line, thus it is not necessary for the data supply line to be provided with a capacitance element for holding data, which is advantageous for miniaturization.

In an aspect of the display device,
the data potential generating circuit may include an amplifier circuit.

An aspect of the display device may include,
a data supply line to which the data potential generated by the data potential generating circuit is supplied,
a data transfer line,
a capacitance element coupled to the data transfer line,
a first switch circuit configured to control electrical coupling between the data line and the data transfer line, and
a second switch circuit configured to control electrical coupling between the data transfer line and the data supply line, wherein
in the first period and the second period, the first switch circuit may be off,
in the first period and the third period, the second switch circuit may be off,
in a period overlapping a part of the second period, the second switch circuit may be on, the data potential output from the data potential generating circuit may be transferred from the data supply line to the data transfer line, and the data potential transferred to the data transfer line may be held in the capacitance element, and
in the third period, the first switch circuit may be on, and the data potential held in the capacitance element may be supplied to the gate of the first transistor.

According to the display device, the data potential transferred from the data supply line to the data transfer line is held in the capacitance element in the period overlapping a part of the second period, and the gate of the first transistor is held at the potential for which the threshold voltage thereof is compensated by the coupling between the capacitance element and the capacitance of the data line in the third period, thus the light-emitting element can emit light with high accuracy thereafter. In addition, according to the display device, the period in which the data potential is transferred from the data supply line to the data transfer line and is held in the capacitance element overlaps a part of the second period, thus it is possible to reduce a time required for writing data to the pixel circuit.

In an aspect of the display device,
in a fourth period after the third period,
the second transistor and the third transistor may be off, the fourth transistor may be on, a current flowing from the source to the drain of the first transistor may be supplied to the light-emitting element via the fourth transistor, and the light-emitting element may emit light.

According to the display device, in the fourth period, the light-emitting element is supplied with a current corresponding to the potential held in the gate of the first transistor in the third period in a state in which the threshold voltage of the first transistor is compensated, and thus can emit light with high accuracy.

An aspect of an electronic apparatus includes
an aspect of the display device.

According to the electronic apparatus, the display device in which the circuit for driving the pixel circuit is simplified and the area size is reduced is included, thus miniaturization is easy.

What is claimed is:

1. A display device, comprising:
a scanning line;
a data line;
a pixel circuit provided corresponding to the scanning line and the data line; and
a data potential generating circuit configured to generate a data potential, wherein
the pixel circuit includes a first transistor, a second transistor, a third transistor, a fourth transistor, and a light-emitting element,
the first transistor having a first gate, a first drain, and a first source,
the first transistor supplies a current in accordance with a voltage between the first gate and the first source to the light-emitting element,
the second transistor controls electrical coupling between the data line and the first gate in accordance with a potential of the scanning line,
the third transistor controls electrical coupling between the data line and the first drain,
the fourth transistor controls electrical coupling between the light-emitting element and the first drain,
in a first period,
the second transistor is on, the third transistor and the fourth transistor are off, and the first gate is supplied with a predetermined first potential via the data line,
in a second period after the first period,
the second transistor and the third transistor are on, the fourth transistor is off, and the data line and the first gate and the first drain are electrically coupled to each other, and
in a third period after the second period,
the second transistor is on, the third transistor and the fourth transistor are off, and the first gate is supplied with the data potential via the data line and the second transistor.

2. The display device according to claim 1, wherein
the data potential generating circuit includes a capacitive DAC that outputs the data potential.

3. The display device according to claim 2, wherein
in the second period, an output node of the capacitive DAC is supplied with a predetermined second potential.

4. The display device according to claim 2, comprising:
a data supply line to which the data potential generated by the data potential generating circuit is supplied; and
a switch circuit configured to control electrical coupling between the data line and the data supply line, wherein
in the first period and the second period, the switch circuit is off, and
in the third period, the switch circuit is on, and the data potential output from the data potential generating circuit is transferred from the data supply line to the data line.

5. The display device according to claim 1, wherein
the data potential generating circuit includes an amplifier circuit.

6. The display device according to claim 1, comprising:
a data supply line to which the data potential generated by the data potential generating circuit is supplied;
a data transfer line;
a capacitance element coupled to the data transfer line;
a first switch circuit configured to control electrical coupling between the data line and the data transfer line; and
a second switch circuit configured to control electrical coupling between the data transfer line and the data supply line, wherein
in the first period and the second period, the first switch circuit is off,
in the first period and the third period, the second switch circuit is off,
in a period overlapping a part of the second period, the second switch circuit is on, the data potential output from the data potential generating circuit is transferred from the data supply line to the data transfer line, and the data potential transferred to the data transfer line is held in the capacitance element, and
in the third period, the first switch circuit is on, and the data potential held in the capacitance element is supplied to the first gate.

7. The display device according to claim 1, wherein
in a fourth period after the third period,
the second transistor and the third transistor are off, the fourth transistor is on, a current flowing from the source to the first drain is supplied to the light-emitting element via the fourth transistor, and the light-emitting element emits light.

8. An electronic apparatus comprising the display device according to claim 1.
